(19) United States
(12) Patent Application Publication
(10) Pub. No.: US 2023/0020328 A1
(43) Pub. Date: Jan. 19, 2023

(54) INFORMATION PROCESSING APPARATUS, IMAGING APPARATUS, INFORMATION PROCESSING METHOD, AND PROGRAM

(71) Applicant: FUJIFILM CORPORATION, Tokyo (JP)

(72) Inventors: Koichi TANAKA, Saitama-shi (JP); Yitong ZHANG, Saitama-shi (JP); Taro SAITO, Saitama-shi (JP); Tomoharu SHIMADA, Saitama-shi (JP)

(21) Appl. No.: 17/954,338

(22) Filed: Sep. 28, 2022

Related U.S. Application Data
(63) Continuation of application No. PCT/JP2022/001631, filed on Jan. 18, 2022.

(30) Foreign Application Priority Data
Jan. 29, 2021 (JP) 2021-013874

(51) Int. Cl. G06T 5/00; G06T 5/50

(52) U.S. Cl. CPC G06T 5/002; G06T 5/50; G06T 2207/20081; G06T 2207/20084; G06T 2207/20216; G06T 2207/10024

(57) ABSTRACT

There is provided an information processing apparatus including a processor and a memory connected to or built into the processor. The processor is configured to process a captured image by using an AI method that uses a neural network and perform composition processing of combining a first image obtained by processing the captured image by using the AI method and a second image obtained by processing the captured image without using the AI method.

### CROSS-REFERENCE TO RELATED APPLICATIONS

This application is a continuation application of International Application No. PCT/JP2022/001631, filed Jan. 18, 2022, the disclosure of which is incorporated herein by reference in its entirety. Further, this application claims priority from Japanese Patent Application No. 2021-013874, filed Jan. 29, 2021, the disclosure of which is incorporated herein by reference in its entirety.

### BACKGROUND

### 1. Technical Field

The present invention relates to an information processing apparatus, an imaging apparatus, an information processing method, and a program.

### 2. Related Art

JP2018-206382A discloses an image processing system including a processing unit that performs processing on an input image, which is input to an input layer, by using a neural network having the input layer, an output layer, and an interlayer provided between the input layer and the output layer, and an adjustment unit that adjusts internal parameters calculated by learning, which are at least one internal parameter of one or more nodes included in the interlayer, based on data related to the input image in a case where the processing is performed after the learning.

Further, in the image processing system described in JP2018-206382A, the input image is an image that includes noise, and the noise is removed or reduced from the input image by the processing performed by the processing unit.

Further, in the image processing system described in JP2018-206382A, the neural network includes a first neural network, a second neural network, a division unit that divides the input image into a high-frequency component image and a low-frequency component image and inputs the high-frequency component image to the first neural network while inputting the low-frequency component image to the second neural network, and a composition unit that combines a first output image output from the first neural network and a second output image output from the second neural network, and an adjustment unit adjusts the internal parameters of the first neural network based on the data related to the input image while not adjusting the internal parameters of the second neural network.

Further, JP2018-206382A discloses the image processing system including the processing unit that generates an output image in which the noise is reduced from the input image by using a neural network and the adjustment unit that adjusts the internal parameters of the neural network according to an imaging condition of the input image.

JP2020-166814A discloses a medical image processing apparatus including an acquisition unit that acquires a first image, which is a medical image of a predetermined portion of a subject, a high image quality unit that generates a second image, which has higher image quality than that of the first image, from the first image by using a high image quality engine including a machine learning engine, and a display control unit that displays a composite image, which is obtained by combining the first image and the second image based on a ratio obtained by using information related to at least a part of a region of the first image, on a display unit.

JP2020-184300A discloses an electronic apparatus including a memory that stores at least one command and a processor that is electrically connected to the memory, obtains a noise map, which indicates a input image quality, from the input image by executing the command, applies the input image and the noise map to a learning network model including a plurality of layers, and obtains an output image having improved input image quality, in which the processor provides a noise map to at least one interlayer among a plurality of layers, and the learning network model is a trained artificial intelligence model obtained by training a relationship between a plurality of sample images, and the noise map for each sample image and an original image for each sample image, by using an artificial intelligence algorithm.

### SUMMARY

One embodiment according to the present disclosed technology provides an information processing apparatus, an imaging apparatus, an information processing method, and a program that can obtain an image with adjusted image quality as compared with a case where an image is processed only with an AI method that uses a neural network.

An information processing apparatus according to a first aspect of the present invention comprises: a processor; and a memory connected to or built into the processor, in which the processor is configured to process a captured image by using an AI method that uses a neural network, and perform composition processing of combining a first image obtained by processing the captured image by using the AI method, and a second image obtained by processing the captured image without using the AI method.

In the information processing apparatus of the first aspect according a second aspect of the present invention, the processor is configured to perform AI method noise adjustment processing of adjusting noise included in the captured image, by using the AI method, and adjust the noise by performing the composition processing.

In the information processing apparatus of the second aspect according a third aspect of the present invention, the processor is configured to perform non-AI method noise adjustment processing of adjusting the noise by using a non-AI method that does not use the neural network, and the second image is an image obtained by adjusting the noise for the captured image by the non-AI method noise adjustment processing.

In the information processing apparatus of the second or the third aspect according a fourth aspect of the present invention, the second image is an image obtained without adjusting the noise for the captured image.

In the information processing apparatus of any one of the second to the fourth aspects according a fifth aspect of the present invention, the processor is configured to apply weights to the first image and the second image, and combine the first image and the second image according to the weights.

In the information processing apparatus of the fifth aspect according a sixth aspect of the present invention, the weights are classified into a first weight applied to the first image and a second weight applied to the second image, and the processor is configured to combine the first image and the second image by performing a weighted average that uses the first weight and the second weight.

In the information processing apparatus of the fifth or the sixth aspect according a seventh aspect of the present invention, the processor is configured to change the weight according to related information that is related to the captured image.

In the information processing apparatus of the seventh aspect according an eighth aspect of the present invention, the related information includes sensitivity related information that is related to sensitivity of an image sensor used in imaging for obtaining the captured image.

In the information processing apparatus of the seventh or the eighth aspect according a ninth aspect of the present invention, the related information includes brightness related information that is related to brightness of the captured image.

In the information processing apparatus of the ninth aspect according a tenth aspect of the present invention, the brightness related information is a pixel statistical value of at least a part of the captured image.

In the information processing apparatus of any one of the seventh to the tenth aspects according an eleventh aspect of the present invention, the related information includes spatial frequency information that indicates a spatial frequency of the captured image.

In the information processing apparatus of any one of the fifth to the eleventh aspects according a twelfth aspect of the present invention, the processor is configured to detect a subject reflected in the captured image, based on the captured image, and change the weight according to the detected subject.

In the information processing apparatus of any one of the fifth to the twelfth aspects according a thirteenth aspect of the present invention, the processor is configured to detect a portion of a subject reflected in the captured image, based on the captured image, and change the weight according to the detected portion.

In the information processing apparatus of any one of the fifth to the thirteenth aspects according a fourteenth aspect of the present invention, the neural network is provided for each imaging scene, and the processor is configured to switch the neural network for each imaging scene, and change the weight according to the neural network.

In the information processing apparatus of any one of the fifth to the fourteenth aspects according a fifteenth aspect of the present invention, the processor is configured to change the weight according to a degree of difference between a feature value of the first image and a feature value of the second image.

In the information processing apparatus of any one of the second to the fifteenth aspects according a sixteenth aspect of the present invention, the processor is configured to normalize an image, which is input to the neural network, with respect to an image characteristic parameter determined according to an image sensor and an imaging condition, which are used for imaging for obtaining an image input to the neural network.

In the information processing apparatus of any one of the second to the sixteenth aspects according a seventeenth aspect of the present invention, an image for learning, which is input to the neural network in a case where the neural network is trained, is an image in which, with respect to at least one first parameter among the number of bits and an offset value of a first RAW image obtained by being captured by a first imaging apparatus, the first RAW image is normalized.

In the information processing apparatus of the eighteenth aspect according an seventeenth aspect of the present invention, the captured image is an image for inference, the first parameter is associated with the neural network to which the image for learning is input, and the processor is configured to, in a case where a second RAW image, which is obtained by being captured by a second imaging apparatus, is input to the neural network where learning is performed by inputting the image for learning, as the image for inference, normalize the second RAW image by using the first parameter associated with the neural network to which the image for learning is input, and at least one second parameter among the number of bits and an offset value of the second RAW image.

In the information processing apparatus of the eighteenth aspect according a nineteenth aspect of the present invention, the first image is a noise adjusted image after normalization, which is obtained by adjusting the noise, for the second RAW image that is normalized by using the first parameter and the second parameter, by the AI method noise adjustment processing that uses the neural network where the learning is performed by inputting the image for learning, and the processor is configured to adjust the noise adjusted image after normalization to an image of the second parameter, by using the first parameter and the second parameter.

In the information processing apparatus of any one of the second to the nineteenth aspects according a twentieth aspect of the present invention, the processor is configured to perform signal processing on the first image and the second image according to a designated set value, and the set value differs between a case where the signal processing is performed on the first image and a case where the signal processing is performed on the second image.

In the information processing apparatus of any one of the second to the twentieth aspects according a twenty-first aspect of the present invention, the processor is configured to perform processing of correcting sharpness which is disappeared due to the AI method noise adjustment processing, on the first image.

In the information processing apparatus of any one of the second to the twenty-first aspects according a twenty-second aspect of the present invention, the first image, which is set as a composition target in the composition processing, is an image indicated by a color difference signal obtained by performing the AI method noise adjustment processing on the captured image.

In the information processing apparatus of any one of the second to the twenty-second aspects according a twenty-third aspect of the present invention, the second image, which is set as a composition target in the composition processing, is an image indicated by a brightness signal obtained without performing the AI method noise adjustment processing on the captured image.

In the information processing apparatus of any one of the second to the twenty-third aspects according a twenty-fourth aspect of the present invention, the first image, which is set as a composition target in the composition processing, is an image indicated by a color difference signal obtained by performing the AI method noise adjustment processing on the captured image, and the second image is an image indicated by a brightness signal obtained without performing the AI method noise adjustment processing on the captured image.

An imaging apparatus according to a twenty-fifth aspect of the present invention comprises: a processor; a memory connected to or built into the processor; and an image sensor, in which the processor is configured to process a captured image, which is obtained by being captured by the image sensor, by using an AI method that uses a neural network, and perform composition processing of combining a first image obtained by processing the captured image by using the AI method, and a second image obtained by processing the captured image without using the AI method.

An information processing method according to a twenty-sixth aspect of the present invention comprises: processing a captured image, which is obtained by being captured by an image sensor, by using an AI method that uses a neural network; and performing composition processing of combining a first image obtained by processing the captured image by using the AI method, and a second image obtained by processing the captured image without using the AI method.

A program according to a twenty-seventh aspect of the present invention that causes a computer to execute a process including: processing a captured image, which is obtained by being captured by an image sensor, by using an AI method that uses a neural network; and performing composition processing of combining a first image obtained by processing the captured image by using the AI method, and a second image obtained by processing the captured image without using the AI method.

### BRIEF DESCRIPTION OF THE DRAWINGS

Exemplary embodiments of the technology of the disclosure will be described in detail based on the following figures, wherein:

FIG. 1 is a schematic configuration diagram showing an example of a configuration of an entire imaging apparatus;

FIG. 2 is a schematic configuration diagram showing an example of hardware configurations of an optical system and an electrical system of the imaging apparatus;

FIG. 3 is a block diagram showing an example of a function of an image processing engine;

FIG. 4 is a conceptual diagram showing an example of a configuration of a learning execution system;

FIG. 5 is a conceptual diagram showing an example of the content of processing of an AI method processing unit and a non-AI method processing unit;

FIG. 6 is a block diagram showing an example of the content of processing of a weight derivation unit;

FIG. 7 is a conceptual diagram showing an example of the content of processing of a weight applying unit and a composition unit;

FIG. 8 is a conceptual diagram showing an example of a function of a signal processing unit;

FIG. 9 is a flowchart showing an example of a flow of image quality adjustment processing;

FIG. 10 is a conceptual diagram showing an example of the content of processing of the weight derivation unit according to a first modification example;

FIG. 11 is a conceptual diagram showing an example of the content of processing of the weight applying unit and the composition unit according to the first modification example;

FIG. 12 is a conceptual diagram showing an example of the content of processing of the weight derivation unit according to a second modification example;

FIG. 13 is a conceptual diagram showing an example of the content of processing of the weight derivation unit according to a third modification example and a fourth modification example;

FIG. 14 is a conceptual diagram showing an example of the content of processing of the weight derivation unit according to a fifth modification example;

FIG. 15 is a block diagram showing an example of the content of a storage of an NVM according to a sixth modification example;

FIG. 16 is a conceptual diagram showing an example of the content of processing of the AI method processing unit according to the sixth modification example;

FIG. 17 is a block diagram showing an example of the content of processing of the weight derivation unit according to the sixth modification example;

FIG. 18 is a conceptual diagram showing an example of a configuration of the learning execution system according to a seventh modification example;

FIG. 19 is a conceptual diagram showing an example of the content of processing content of the image processing engine according to the seventh modification example;

FIG. 20 is a block diagram showing an example of functions of the signal processing unit and a parameter adjustment unit according to an eighth modification example;

FIG. 21 is a conceptual diagram showing an example of the content of processing of the AI method processing unit, the non-AI method processing unit, and the signal processing unit according to a ninth modification example;

FIG. 22 is a conceptual diagram showing an example of the content of processing of a first image processing unit according to the ninth modification example;

FIG. 23 is a conceptual diagram showing an example of the content of processing of a second image processing unit according to the ninth modification example;

FIG. 24 is a conceptual diagram showing an example of the content of processing content of the composition unit according to the ninth modification example;

FIG. 25 is a conceptual diagram showing a modification example of the image quality adjustment processing; and

FIG. 26 is a schematic configuration diagram showing an example of an imaging system.

### DETAILED DESCRIPTION

Hereinafter, an example of an embodiment of an image processing apparatus, an imaging apparatus, an image processing method, and a program according to the present disclosed technology will be described with reference to the accompanying drawings.

First, the wording used in the following description will be described.

CPU refers to an abbreviation of a “Central Processing Unit”. GPU refers to an abbreviation of a “Graphics Processing Unit”. TPU refers to an abbreviation of a “Tensor processing unit”. NVM refers to an abbreviation of a “Non-volatile memory”. RAM refers to an abbreviation of a “Random Access Memory”. IC refers to an abbreviation of an “Integrated Circuit”. ASIC refers to an abbreviation of an “Application Specific Integrated Circuit”. PLD refers to an abbreviation of a “Programmable Logic Device”. FPGA refers to an abbreviation of a “Field-Programmable Gate Array”. SoC refers to an abbreviation of a “System-on-a-chip”. SSD refers to an abbreviation of a “Solid State Drive”. USB refers to an abbreviation of a “Universal Serial Bus”. HDD refers to an abbreviation of a “Hard Disk Drive”. EEPROM refers to an abbreviation of an “Electrically Erasable and Programmable Read Only Memory”. EL refers to an abbreviation of “Electro-Luminescence”. I/F refers to an abbreviation of an “Interface”. UI refers to an abbreviation of a “User Interface”. fps refers to an abbreviation of a “frame per second”. MF refers to an abbreviation of “Manual Focus”. AF refers to an abbreviation of “Auto Focus”. CMOS refers to an abbreviation of a “Complementary Metal Oxide Semiconductor”. CCD refers to an abbreviation of a “Charge Coupled Device”. LAN refers to an abbreviation of a “Local Area Network”. WAN refers to an abbreviation of a “Wide Area Network”. NN refers to an abbreviation of a “Neural Network”. CNN refers to an abbreviation of a “Convolutional Neural Network”. AI refers to an abbreviation of “Artificial Intelligence”. A/D refers to an abbreviation of “Analog/Digital”. FIR refers to an abbreviation of a “Finite Impulse Response”. IIR refers to an abbreviation of an “Infinite Impulse Response”. JPEG refers to an abbreviation of a “Joint Photographic Experts Group”. TIFF refers to an abbreviation of a “Tagged Image File Format”. JPEG XR refers to an abbreviation of a “Joint Photographic Experts Group Extended Range”. ID refers to an abbreviation of an “Identification”. LSB refers to an abbreviation of a “Least Significant Bit”.

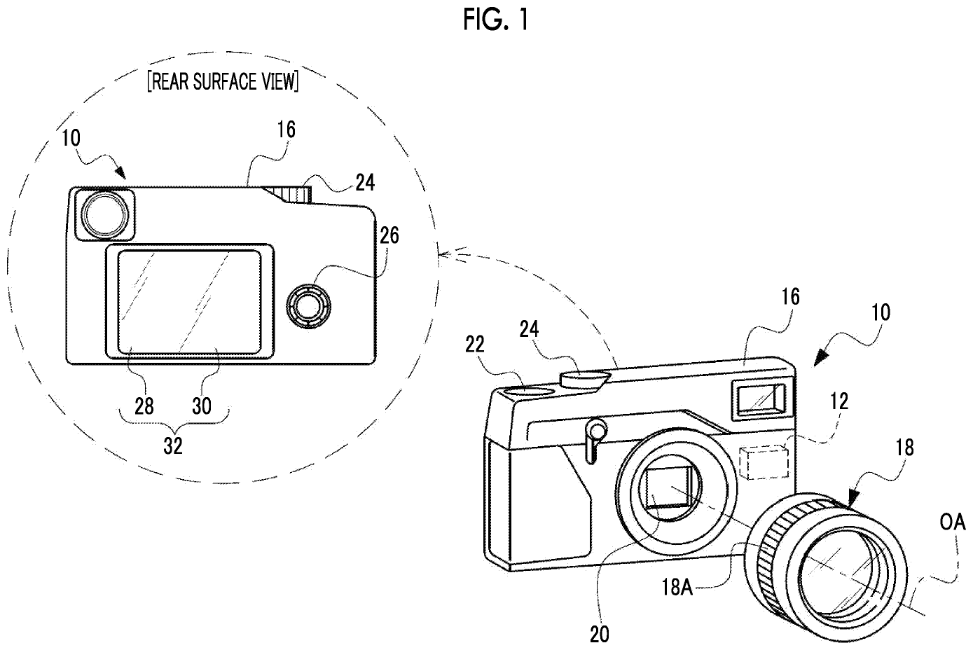

As an example shown in FIG. 1, the imaging apparatus 10 is an apparatus for imaging a subject and includes an image processing engine 12, an imaging apparatus main body 16, and an interchangeable lens 18. The image processing engine 12 is an example of an “information processing apparatus” and a “computer” according to the present disclosed technology. The image processing engine 12 is built into the imaging apparatus main body 16 and controls the entire imaging apparatus 10. The interchangeable lens 18 is interchangeably attached to the imaging apparatus main body 16. The interchangeable lens 18 is provided with a focus ring 18A. In a case where a user or the like of the imaging apparatus 10 (hereinafter, simply referred to as the “user”) manually adjusts the focus on the subject by the imaging apparatus 10, the focus ring 18A is operated by the user or the like.

In the example shown in FIG. 1, a lens-interchangeable digital camera is shown as an example of the imaging apparatus 10. However, this is only an example, and a digital camera with a fixed lens may be used or a digital camera, which is built into various electronic devices such as a smart device, a wearable terminal, a cell observation device, an ophthalmologic observation device, or a surgical microscope may be used.

An image sensor 20 is provided in the imaging apparatus main body 16. The image sensor 20 is an example of an “image sensor” according to the present disclosed technology. The image sensor 20 is a CMOS image sensor. The image sensor 20 captures an imaging range including at least one subject. In a case where the interchangeable lens 18 is attached to the imaging apparatus main body 16, subject light indicating the subject is transmitted through the interchangeable lens 18 and imaged on the image sensor 20, and then image data indicating an image of the subject is generated by the image sensor 20.

In the present embodiment, although the CMOS image sensor is exemplified as the image sensor 20, the present disclosed technology is not limited to this, for example, the present disclosed technology is established even in a case where the image sensor 20 is another type of image sensor such as a CCD image sensor.

A release button 22 and a dial 24 are provided on an upper surface of the imaging apparatus main body 16. The dial 24 is operated in a case where an operation mode of the imaging system, an operation mode of a playback system, and the like are set, and by operating the dial 24, an imaging mode, a playback mode, and a setting mode are selectively set as the operation mode in the imaging apparatus 10. The imaging mode is an operation mode in which the imaging is performed with respect to the imaging apparatus 10. The playback mode is an operation mode for playing the image (for example, a still image and/or a moving image) obtained by the performance of the imaging for recording in the imaging mode. The setting mode is an operation mode for setting the imaging apparatus 10 in a case where various set values used in the control related to the imaging are set.

The release button 22 functions as an imaging preparation instruction unit and an imaging instruction unit, and is capable of detecting a two-step pressing operation of an imaging preparation instruction state and an imaging instruction state. The imaging preparation instruction state refers to a state in which the release button 22 is pressed, for example, from a standby position to an intermediate position (half pressed position), and the imaging instruction state refers to a state in which the release button 22 is pressed to a final pressed position (fully pressed position) beyond the intermediate position. In the following, the “state of being pressed from the standby position to the half pressed position” is referred to as a “half pressed state”, and the “state of being pressed from the standby position to the full pressed position” is referred to as a “fully pressed state”. Depending on the configuration of the imaging apparatus 10, the imaging preparation instruction state may be a state in which the user's finger is in contact with the release button 22, and the imaging instruction state may be a state in which the operating user's finger is moved from the state of being in contact with the release button 22 to the state of being away from the release button 22.

An instruction key 26 and a touch panel display 32 are provided on a rear surface of the imaging apparatus main body 16.

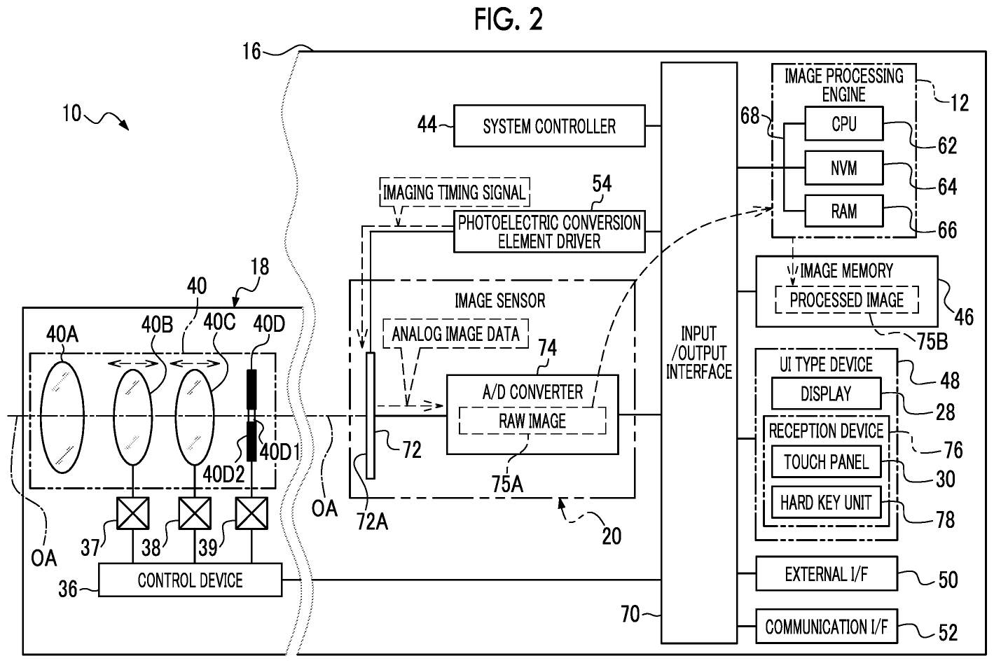

The touch panel display 32 includes a display 28 and a touch panel 30 (see also FIG. 2). Examples of the display 28 include an EL display (for example, an organic EL display or an inorganic EL display). The display 28 may not be an EL display but may be another type of display such as a liquid crystal display.

The display 28 displays image and/or character information and the like. The display 28 is used for imaging for a live view image, that is, for displaying a live view image obtained by performing the continuous imaging in a case where the imaging apparatus 10 is in the imaging mode. Here, the “live view image” refers to a moving image for display based on the image data obtained by being imaged by the image sensor 20. The imaging, which is performed to obtain the live view image (hereinafter, also referred to as “imaging for a live view image”), is performed according to, for example, a frame rate of 60 fps. 60 fps is only an example, and a frame rate of fewer than 60 fps may be used, or a frame rate of more than 60 fps may be used.

The display 28 is also used for displaying a still image obtained by the performance of the imaging for a still image in a case where an instruction for performing the imaging for a still image is provided to the imaging apparatus 10 via the release button 22. The display 28 is also used for displaying a playback image or the like in a case where the imaging apparatus 10 is in the playback mode. Further, the display 28 is also used for displaying a menu screen where various menus can be selected and displaying a setting screen for setting the various set values used in control related to the imaging in a case where the imaging apparatus 10 is in the setting mode.

The touch panel 30 is a transmissive touch panel and is superimposed on a surface of a display region of the display 28. The touch panel 30 receives the instruction from the user by detecting contact with an indicator such as a finger or a stylus pen. In the following, for convenience of explanation, the above-mentioned “fully pressed state” includes a state in which the user turns on a softkey for starting the imaging via the touch panel 30.

In the present embodiment, although an out-cell type touch panel display in which the touch panel 30 is superimposed on the surface of the display region of the display 28 is exemplified as an example of the touch panel display 32, this is only an example. For example, as the touch panel display 32, an on-cell type or in-cell type touch panel display can be applied.

The instruction key 26 receives various instructions. Here, the “various instructions” refer to, for example, various instructions such as an instruction for displaying the menu screen, an instruction for selecting one or a plurality of menus, an instruction for confirming a selected content, an instruction for erasing the selected content, zooming in, zooming out, frame forwarding, and the like. Further, these instructions may be provided by the touch panel 30.

As an example shown in FIG. 2, the image sensor 20 includes photoelectric conversion elements 72. The photoelectric conversion elements 72 have a light receiving surface 72A. The photoelectric conversion elements 72 are disposed in the imaging apparatus main body 16 such that the center of the light receiving surface 72A and an optical axis OA coincide with each other (see also FIG. 1). The photoelectric conversion elements 72 have a plurality of photosensitive pixels arranged in a matrix shape, and the light receiving surface 72A is formed by the plurality of photosensitive pixels. Each photosensitive pixel has a micro lens (not shown). The photosensitive pixel is a physical pixel having a photodiode (not shown), which photoelectrically converts the received light and outputs an electric signal according to the light receiving amount.

Further, red (R), green (G), or blue (B) color filters (not shown) are arranged in a matrix shape in a default pattern arrangement (for example, Bayer arrangement, G stripe R/G complete checkered pattern, X-Trans (registered trademark) arrangement, honeycomb arrangement, or the like) on the plurality of photosensitive pixels.

In the following, for convenience of explanation, a photosensitive pixel having a micro lens and an R color filter is referred to as an R pixel, a photosensitive pixel having a micro lens and a G color filter is referred to as a G pixel, and a photosensitive pixel having a micro lens and a B color filter is referred to as a B pixel. Further, in the following, for convenience of explanation, the electric signal output from the R pixel is referred to as an “R signal”, the electric signal output from the G pixel is referred to as a “G signal”, and the electric signal output from the B pixel is referred to as a “B signal”. Further, in the following, for convenience of explanation, the R signal, the G signal, and the B signal are also referred to as “RGB color signals”.

The interchangeable lens 18 includes an imaging lens 40. The imaging lens 40 has an objective lens 40A, a focus lens 40B, a zoom lens 40C, and a stop 40D. The objective lens 40A, the focus lens 40B, the zoom lens 40C, and the stop 40D are disposed in the order of the objective lens 40A, the focus lens 40B, the zoom lens 40C, and the stop 40D along the optical axis OA from the subject side (object side) to the imaging apparatus main body 16 side (image side).

Further, the interchangeable lens 18 includes a control device 36, a first actuator 37, a second actuator 38, and a third actuator 39. The control device 36 controls the entire interchangeable lens 18 according to the instruction from the imaging apparatus main body 16. The control device 36 is a device having a computer including, for example, a CPU, an NVM, a RAM, and the like. The NVM of the control device 36 is, for example, an EEPROM. However, this is only an example, and an HDD and/or SSD or the like may be applied as the NVM of a system controller 44 instead of or together with the EEPROM. Further, the RAM of the control device 36 temporarily stores various information and is used as a work memory. In the control device 36, the CPU reads a necessary program from the NVM and executes the read various programs on the RAM to control the entire imaging lens 40.

Although a device having a computer is exemplified here as an example of the control device 36, this is only an example, and a device including an ASIC, FPGA, and/or PLD may be applied. Further, as the control device 36, for example, a device implemented by a combination of a hardware configuration and a software configuration may be used.

The first actuator 37 includes a slide mechanism for focus(not shown) and a motor for focus (not shown). The focus lens 40B is attached to the slide mechanism for focus so as to be slidable along the optical axis OA. Further, the motor for focus is connected to the slide mechanism for focus, and the slide mechanism for focus operates by receiving the power of the motor for focus to move the focus lens 40B along the optical axis OA.

The second actuator 38 includes a slide mechanism for zoom (not shown) and a motor for zoom (not shown). The zoom lens 40C is attached to the slide mechanism for zoom so as to be slidable along the optical axis OA. Further, the motor for zoom is connected to the slide mechanism for zoom, and the slide mechanism for zoom operates by receiving the power of the motor for zoom to move the zoom lens 40C along the optical axis OA.

The third actuator 39 includes a power transmission mechanism (not shown) and a motor for stop (not shown). The stop 40D has an opening 40D1 and is a stop in which the size of the opening 40D1 is variable. The opening 40D1 is formed by a plurality of stop leaf blades 40D2, for example. The plurality of stop leaf blades 40D2 are connected to the power transmission mechanism. Further, the motor for stop is connected to the power transmission mechanism, and the power transmission mechanism transmits the power of the motor for stop to the plurality of stop leaf blades 40D2. The plurality of stop leaf blades 40D2 receives the power that is transmitted from the power transmission mechanism and changes the size of the opening 40D1 by being operated. The stop 40D adjusts the exposure by changing the size of the opening 40D1.

The motor for focus, the motor for zoom, and the motor for stop are connected to the control device 36, and the control device 36 controls each drive of the motor for focus, the motor for zoom, and the motor for stop. In the present embodiment, a stepping motor is adopted as an example of the motor for focus, the motor for zoom, and the motor for stop. Therefore, the motor for focus, the motor for zoom, and the motor for stop operate in synchronization with a pulse signal in response to a command from the control device 36. Although an example in which the motor for focus, the motor for zoom, and the motor for stop are provided in the interchangeable lens 18 has been described here, this is only an example, and at least one of the motor for focus, the motor for zoom, or the motor for stop may be provided in the imaging apparatus main body 16. The constituent and/or operation method of the interchangeable lens 18 can be changed as needed.

In the imaging apparatus 10, in the case of the imaging mode, an MF mode and an AF mode are selectively set according to the instructions provided to the imaging apparatus main body 16. The MF mode is an operation mode for manually focusing. In the MF mode, for example, by operating the focus ring 18A or the like by the user, the focus lens 40B is moved along the optical axis OA with the movement amount according to the operation amount of the focus ring 18A or the like, thereby the focus is adjusted.

In the AF mode, the imaging apparatus main body 16 calculates a focusing position according to a subject distance and adjusts the focus by moving the focus lens 40B toward the calculated focusing position. Here, the focusing position refers to a position of the focus lens 40B on the optical axis OA in a state of being in focus.

The imaging apparatus main body 16 includes the image sensor 20, the image processing engine 12, the system controller 44, an image memory 46, a UI type device 48, an external I/F 50, a communication I/F 52, a photoelectric conversion element driver 54, and an input/output interface 70. Further, the image sensor 20 includes the photoelectric conversion elements 72 and an A/D converter 74.

The image processing engine 12, the image memory 46, the UI type device 48, the external I/F 50, the photoelectric conversion element driver 54, and the A/D converter 74 are connected to the input/output interface 70. Further, the control device 36 of the interchangeable lens 18 is also connected to the input/output interface 70.

The system controller 44 includes a CPU (not shown), an NVM (not shown), and a RAM (not shown). In the system controller 44, the NVM is a non-temporary storage medium and stores various parameters and various programs. The NVM of the system controller 44 is, for example, an EEPROM. However, this is only an example, and an HDD and/or SSD or the like may be applied as the NVM of a system controller 44 instead of or together with the EEPROM. Further, the RAM of the system controller 44 temporarily stores various information and is used as a work memory. In the system controller 44, the CPU reads a necessary program from the NVM and executes the read various programs on the RAM to control the entire imaging apparatus 10. That is, in the example shown in FIG. 2, the image processing engine 12, the image memory 46, the UI type device 48, the external I/F 50, the communication I/F 52, the photoelectric conversion element driver 54, and the control device 36 are controlled by the system controller 44.

The image processing engine 12 operates under the control of the system controller 44. The image processing engine 12 includes a CPU 62, an NVM 64, and a RAM 66. Here, the CPU 62 is an example of a “processor” according to the present disclosed technology, and the NVM 64 is an example of a “memory” according to the present disclosed technology.

The CPU 62, the NVM 64, and the RAM 66 are connected via a bus 68, and the bus 68 is connected to the input/output interface 70. In the example shown in FIG. 2, one bus is shown as the bus 68 for convenience of illustration, but a plurality of buses may be used. The bus 68 may be a serial bus or may be a parallel bus including a data bus, an address bus, a control bus, and the like.

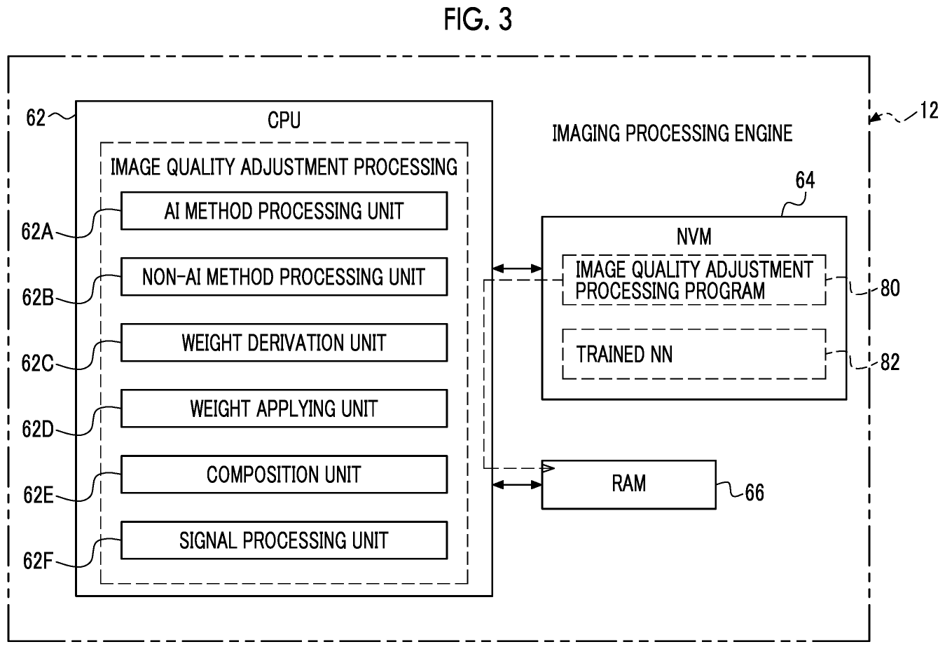

The NVM 64 is a non-temporary storage medium and stores various parameters and various programs, which are different from the various parameters and various programs stored in the NVM of the system controller 44. The various programs include an image quality adjustment processing program 80 (see FIG. 3), which will be described later. For example, the NVM 64 is an EEPROM. However, this is only an example, and an HDD and/or SSD or the like may be applied as the NVM 64 instead of or together with the EEPROM. Further, the RAM 66 temporarily stores various information and is used as a work memory.

The CPU 62 reads a necessary program from the NVM 64 and executes the read program in the RAM 66. The CPU 62 performs image processing according to a program executed on the RAM 66.

The photoelectric conversion element driver 54 is connected to the photoelectric conversion elements 72. The photoelectric conversion element driver 54 supplies an imaging timing signal, which defines the timing of the imaging performed by the photoelectric conversion elements 72, to the photoelectric conversion elements 72 according to an instruction from the CPU 62. The photoelectric conversion elements 72 perform reset, exposure, and output of an electric signal according to the imaging timing signal supplied from the photoelectric conversion element driver 54. Examples of the imaging timing signal include a vertical synchronization signal, and a horizontal synchronization signal.

In a case where the interchangeable lens 18 is attached to the imaging apparatus main body 16, the subject light incident on the imaging lens 40 is imaged on the light receiving surface 72A by the imaging lens 40. Under the control of the photoelectric conversion element driver 54, the photoelectric conversion elements 72 photoelectrically convert the subject light, which is received from the light receiving surface 72A and output the electric signal corresponding to the amount of light of the subject light to the A/D converter 74 as analog image data indicating the subject light. Specifically, the A/D converter 74 reads the analog image data from the photoelectric conversion elements 72 in units of one frame and for each horizontal line by using an exposure sequential reading method.

The A/D converter 74 generates a RAW image 75A by digitizing analog image data. The RAW image 75A is an example of a “captured image” according to the present disclosed technology. The RAW image 75A is an image in which the R pixels, the G pixels, and the B pixels are arranged in a mosaic shape. Further, in the present embodiment, as an example, the number of bits of each of the R pixel, the B pixel, and the G pixel included in the RAW image 75A, that is, the length of the bits is 14 bits.

In the present embodiment, as an example, the CPU 62 of the image processing engine 12 acquires the RAW image 75A from the A/D converter 74 and performs the image processing on the acquired RAW image 75A.

A processed image 75B is stored in the image memory 46. The processed image 75B is an image obtained by performing the image processing on the RAW image 75A by the CPU 62.

The UI type device 48 includes a display 28, and the CPU 62 displays various information on the display 28. Further, the UI type device 48 includes a reception device 76. The reception device 76 includes a touch panel 30 and a hard key unit 78. The hard key unit 78 is a plurality of hard keys including an instruction key 26 (see FIG. 1). The CPU 62 operates according to various instructions received by using the touch panel 30. Here, although the hard key unit 78 is included in the UI type device 48, the present disclosed technology is not limited to this, for example, the hard key unit 78 may be connected to the external I/F 50.

The external I/F 50 controls the exchange of various information between the imaging apparatus 10 and an apparatus existing outside the imaging apparatus 10 (hereinafter, also referred to as an “external apparatus”). Examples of the external I/F 50 include a USB interface. The external apparatus (not shown) such as a smart device, a personal computer, a server, a USB memory, a memory card, and/or a printer is directly or indirectly connected to the USB interface.

The communication I/F 52 is connected to a network (not shown). The communication I/F 52 controls the exchange of information between a communication device (not shown) such as a server on the network and the system controller 44. For example, the communication I/F 52 transmits information in response to a request from the system controller 44 to the communication device via the network. Further, the communication I/F 52 receives the information transmitted from the communication device and outputs the received information to the system controller 44 via the input/output interface 70.

As an example shown in FIG. 3, the image quality adjustment processing program 80 is stored in the NVM 64 of the imaging apparatus 10. The image quality adjustment processing program 80 is an example of a “program” according to the present disclosed technology. Further, a trained neural network 82 is stored in the NVM 64 of the imaging apparatus 10. In the following, for convenience of explanation, the “neural network” is abbreviated and also referred to as “NN”.

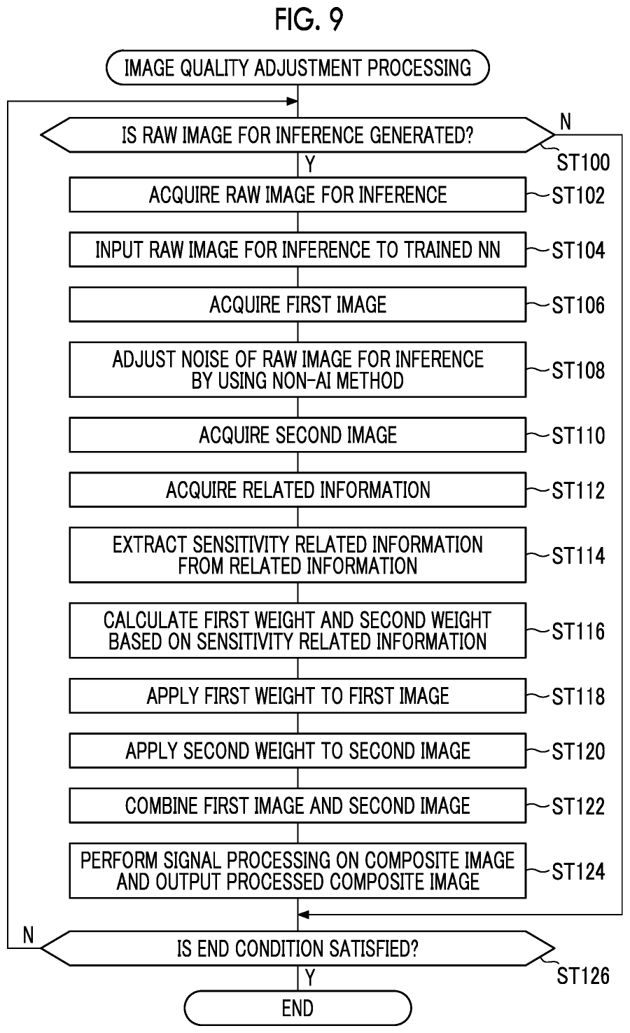

The CPU 62 reads the image quality adjustment processing program 80 from the NVM 64 and executes the read image quality adjustment processing program 80 on the RAM 66. The CPU 62 performs image quality adjustment processing (see FIG. 9) according to the image quality adjustment processing program 80 executed on the RAM 66. The image quality adjustment processing is implemented by operating the CPU 62 as an AI method processing unit 62A, a non-AI method processing unit 62B, a weight derivation unit 62C, a weight applying unit 62D, a composition unit 62E, and a signal processing unit 62F according to the image quality adjustment processing program 80.

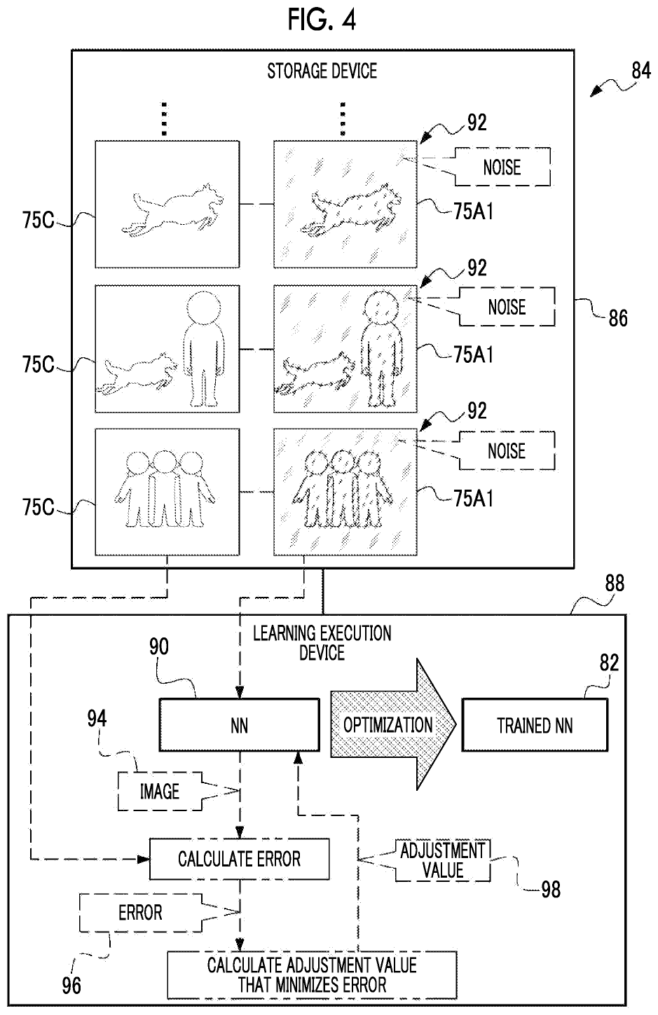

As an example shown in FIG. 4, a trained NN 82 is generated by the learning execution system 84. The learning execution system 84 includes a storage device 86 and a learning execution device 88. Examples of the storage device 86 include an HDD. The HDD is only an example, and another type of storage device such as an SSD may be used. Further, the learning execution device 88 is a device implemented by a computer or the like having a CPU (not shown), an NVM (not shown), and a RAM (not shown).

The trained NN 82 is generated by performing a machine learning on an NN 90 by the learning execution device 88. The trained NN 82 is a trained model generated by optimizing the NN 90 by the machine learning. Examples of the NN 90 include a CNN.

A plurality of (for example, tens of thousands to hundreds of billions) of teacher data 92 are stored in the storage device 86. The learning execution device 88 is connected to the storage device 86. The learning execution device 88 acquires the plurality of teacher data 92 from the storage device 86 and performs the machine learning on the NN 90 by using the acquired plurality of teacher data 92.

The teacher data 92 is labeled data. The labeled data is, for example, data in which the RAW image 75A1 for learning and the correction data 75C are associated with each other. Examples of the RAW image 75A1 for learning include a RAW image 75A obtained by being captured by the imaging apparatus 10 and/or a RAW image obtained by being captured by an imaging apparatus different from the imaging apparatus 10.

The correction data 75C is an image in which noise is removed from the RAW image 75A1 for learning. Here, the noise refers to noise caused by, for example, the imaging performed by the imaging apparatus 10. Examples of the noise include pixel defects, dark current noise, and/or beat noise.

The learning execution device 88 acquires the teacher data 92 one by one from the storage device 86. The learning execution device 88 inputs the RAW image 75A1 for learning to the NN 90 from the teacher data 92 acquired from the storage device 86. In a case where the RAW image 75A1 for learning is input, the NN 90 performs an inference and outputs an image 94 showing an inference result.

The learning execution device 88 calculates an error 96 between the correction data 75C, which is associated with the RAW image 75A1 for learning that is input to the NN 90, and the image 94. The learning execution device 88 calculates a plurality of adjustment values 98 that minimize the error 96. Thereafter, the learning execution device 88 adjusts a plurality of optimization variables in the NN 90 by using the plurality of adjustment values 98. Here, the plurality of optimization variables refer to, for example, a plurality of bonding loads and a plurality of offset values included in the NN 90, and the like.

The learning execution device 88 repeatedly performs the learning processing of inputting the RAW image 75A1 for learning to NN 90, calculating the error 96, calculating the plurality of adjustment values 98, and adjusting the plurality of optimization variables in NN 90, by using the plurality of teacher data 92 stored in the storage device 86. That is, the learning execution device 88 optimizes the NN 90 by adjusting the plurality of optimization variables in the NN 90 by using the plurality of adjustment values 98 calculated so as to minimize the error 96 for each of the plurality of RAW images 75A1 for learning included in the plurality of teacher data 92 stored in the storage device 86.

The learning execution device 88 generates the trained NN 82 by optimizing the NN 90. The learning execution device 88 is connected to the external I/F 50 or the communication I/F 52 (see FIG. 2) of the imaging apparatus main body 16 and stores the trained NN 82 in the NVM 64 (see FIG. 3).

By the way, for example, in a case where the RAW image 75A (see FIG. 2) is input to the trained NN 82, an image in which most of the noise is removed is output from the trained NN 82. In a case where the noise, which is included in the RAW image 75A as the characteristics of the trained NN 82, is removed, it is conceivable that a fine structure (for example, fine contours and/or fine patterns of the subject) of the subject reflected in the RAW image 75A is also reduced. In a case where the fine structure of the subject is reduced, the RAW image 75A may become an image with poor sharpness. It is considered that the reason why such an image is obtained from the trained NN 82 is that the trained NN 82 is not good at discriminating between the noise and the fine structure of the subject. In particular, in a case where the number of layers included in the NN 90 is reduced and the trained NN 82 is simplified, it is expected that it may be more difficult for the trained NN 82 to discriminate between the noise and the fine structure (hereinafter, also referred to as a “microstructure”) of the subject.

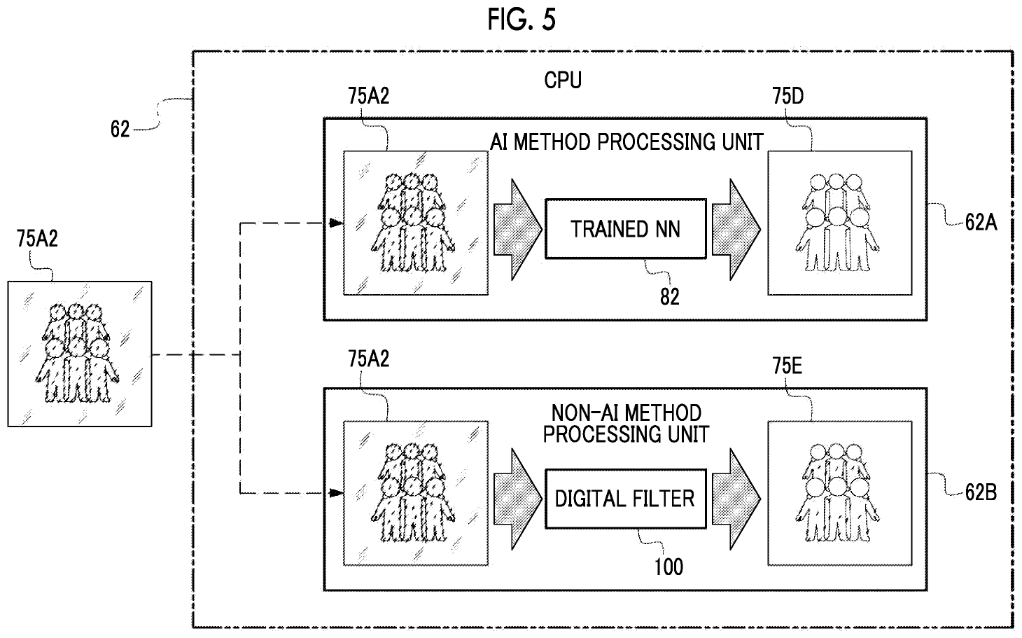

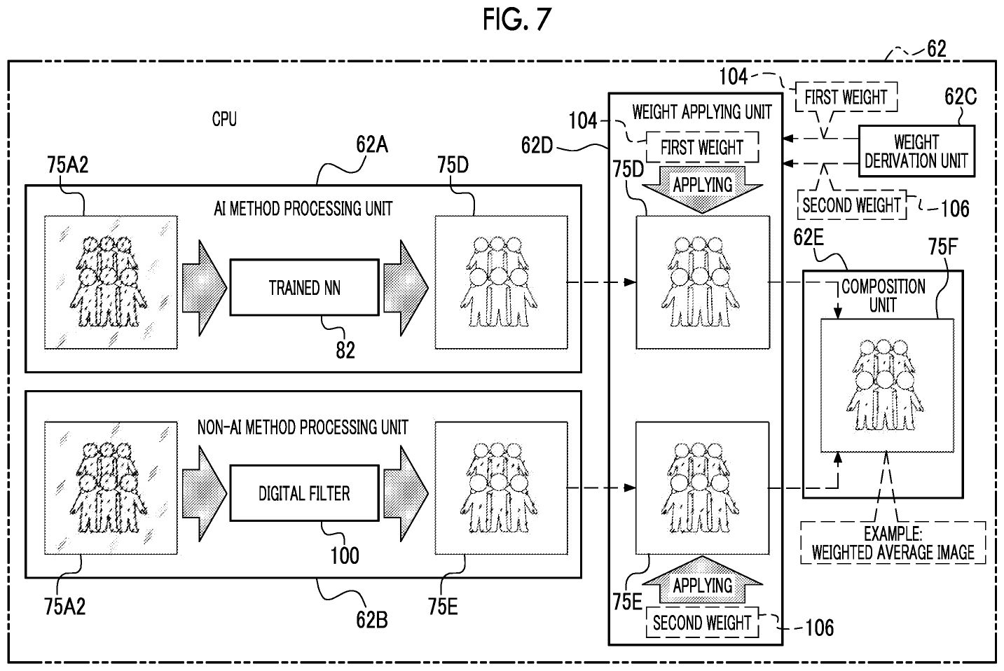

In view of such circumstances, the imaging apparatus 10 is configured such that the image quality adjustment processing (see FIGS. 3 and 6 to 9) is performed by the CPU 62. The CPU 62 processes a RAW image 75A2 for inference (see FIG. 5) by using the AI method that uses the trained NN 82 by performing the image quality adjustment processing, and performs composition processing of combining a first image 75D (see FIGS. 5 and 7), which is obtained by processing the RAW image 75A2 for inference by using the AI method, and a second image 75E (see FIGS. 5 and 7), which is obtained by processing the RAW image 75A2 for inference without using the AI method. The RAW image 75A2 for inference is an image where inference is performed by the trained NN 82. In the present embodiment, the RAW image 75A, which is obtained by being captured by the imaging apparatus 10, is applied as the RAW image 75A2 for inference. The RAW image 75A is only an example, and the RAW image 75A2 for inference may be an image other than the RAW image 75A (for example, an image where the RAW image 75A is processed).

As an example shown in FIG. 5, the RAW image 75A2 for inference is input to the AI method processing unit 62A. The AI method processing unit 62A performs AI method noise adjustment processing on the RAW image 75A2 for inference. The AI method noise adjustment processing is processing of adjusting the noise included in the RAW image 75A2 for inference by using the AI method. The AI method processing unit 62A performs the processing using the trained NN 82 as the AI method noise adjustment processing.

In this case, the AI method processing unit 62A inputs the RAW image 75A2 for inference to the trained NN 82. In a case where the RAW image 75A2 for inference is input, the trained NN 82 performs the inference on the RAW image 75A2 for inference and outputs the first image 75D as the inference result. The first image 75D is an image in which the noise is reduced as compared with the RAW image 75A2 for inference. The first image 75D is an example of a “first image” according to the present disclosed technology.

Similar to the AI method processing unit 62A, the RAW image 75A2 for inference is also input to the non-AI method processing unit 62B. The non-AI method processing unit 62B performs non-AI method noise adjustment processing on the RAW image 75A2 for inference. The non-AI method noise adjustment processing is processing of adjusting the noise included in the RAW image 75A2 for inference by using a non-AI method that does not use NN.

The non-AI method processing unit 62B has a digital filter 100. The non-AI method processing unit 62B performs processing using the digital filter 100 as the non-AI method noise adjustment processing. The digital filter 100 is, for example, an FIR filter. The FIR filter is only an example and may be another digital filter such as an IIR filter, as long as it is a digital filter having a function of reducing the noise included in the RAW image 75A2 for inference by using the non-AI method.

The non-AI method processing unit 62B generates the second image 75E by performing filtering on the RAW image 75A2 for inference by using the digital filter 100. The second image 75E is an image obtained by performing the filtering by the digital filter 100, that is, an image obtained by adjusting the noise by the non-AI method noise adjustment processing. The second image 75E is an image in which the noise is reduced as compared with the RAW image 75A2 for inference, but is also an image in which the noise remains as compared with the first image 75D. The second image 75E is an example of a “second image” according to the present disclosed technology.

In the second image 75E, the microstructure, which is reduced by the trained NN 82, from the RAW image 75A2 for inference also remains while the noise, which is removed by the trained NN 82, from the RAW image 75A2 for inference remains. Therefore, the CPU 62 not only reduces the noise, but also generates an image in which the disappearance of the microstructure is avoided (for example, an image that maintains the sharpness) by combining the first image 75D and the second image 75E.

Examples of one of the causes of the noise entering the RAW image 75A2 for inference include the sensitivity of the image sensor 20 (for example, ISO sensitivity). This is because the sensitivity of the image sensor 20 depends on an analog gain used for amplifying the analog image data, and by increasing the analog gain, the noise is also increased. Further, in the present embodiment, the ability to remove the noise caused by the sensitivity of the image sensor 20 is different between the trained NN 82 and the digital filter 100.

Therefore, the CPU 62 applies different weights to the first image 75D and the second image 75E, which are set as composition targets, and combines the first image 75D and the second image 75E according to the applied weights. The weights applied to the first image 75D and the second image 75E refer to the degree of pixel values of the first image 75D and the degree of pixel values of the second image 75E used for combining pixels corresponding to pixel positions between the first image 75D and the second image 75E.

For example, in a case where the digital filter 100 has a lower ability to remove the noise caused by the sensitivity of the image sensor 20 than that of the trained NN 82, a smaller weight is applied to the first image 75D than to the second image 75E. Further, a difference in weights applied to the first image 75D and the second image 75E is determined according to a difference or the like in the ability to remove the noise caused by the sensitivity of the image sensor 20.

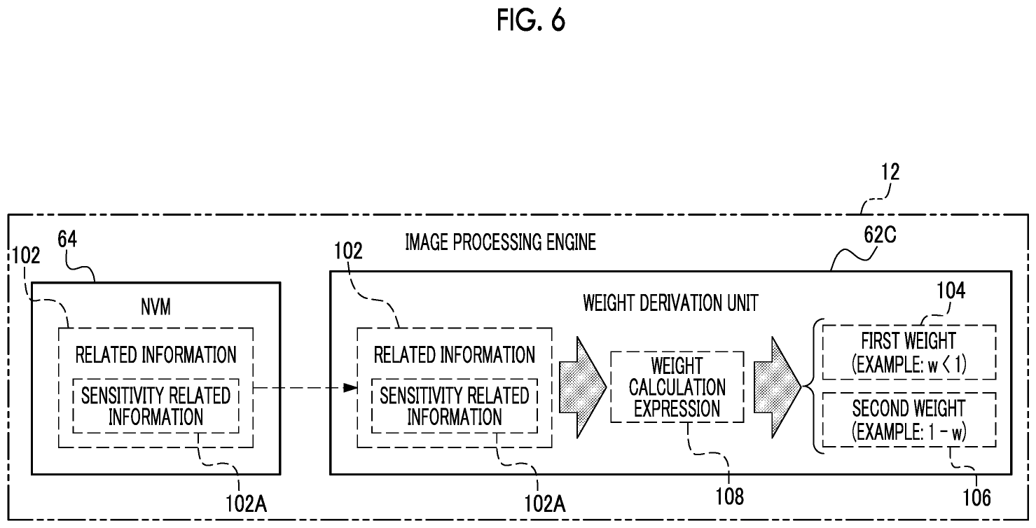

As an example shown in FIG. 6, related information 102 is stored in the NVM 64. The related information 102 is information related to the RAW image 75A2 for inference. The related information 102 includes sensitivity related information 102A. The sensitivity related information 102A is information related to the sensitivity of the image sensor 20 used in the imaging for obtaining the RAW image 75A2 for inference. Examples of the sensitivity related information 102A include information indicating the ISO sensitivity.

The weight derivation unit 62C acquires the related information 102 from the NVM 64. The weight derivation unit 62C derives the first weight 104 and the second weight 106 as the weights applied to the first image 75D and the second image 75E, based on the related information 102 acquired from the NVM 64. The weights applied to the first image 75D and the second image 75E are classified into the first weight 104 and the second weight 106. The first weight 104 is a weight applied to the first image 75D, and the second weight 106 is a weight applied to the second image 75E.

The weight derivation unit 62C has a weight calculation expression 108. The weight calculation expression 108 is a calculation expression in which a parameter that is specified from the related information 102 is set to an independent variable and the first weight 104 is set to a dependent variable. Here, examples of the parameter specified based on the related information 102 include a value indicating the sensitivity of the image sensor 20. A value indicating the sensitivity of the image sensor 20 is specified based on the sensitivity related information 102A. Examples of the value indicating the sensitivity of the image sensor 20 include a value indicating the ISO sensitivity. However, this is only an example, and the value indicating the sensitivity of the image sensor 20 may be a value indicating an analog gain.

The weight derivation unit 62C calculates the first weight 104 by substituting the value indicating the sensitivity of the image sensor 20 into the weight calculation expression 108. Here, assuming that the first weight 104 is “w”, the first weight 104 is a value that satisfies a magnitude relationship of “0<w<1”. The second weight is “1−w”. The weight derivation unit 62C calculates the second weight 106 from the first weight 104 calculated by using the weight calculation expression 108.

As described above, since the first weight 104 and the second weight 106 are values depending on the related information 102, the first weight 104 and the second weight 106, which are calculated by the weight derivation unit 62C, are changed based on the related information 102. For example, the first weight 104 and the second weight 106 are changed by the weight derivation unit 62C according to the value indicating the sensitivity of the image sensor 20.

As an example shown in FIG. 7, the weight applying unit 62D acquires the first image 75D from the AI method processing unit 62A and the second image 75E from the non-AI method processing unit 62B. The weight applying unit 62D applies the first weight 104 derived by the weight derivation unit 62C to the first image 75D. The weight applying unit 62D applies the second weight 106 derived by the weight derivation unit 62C to the second image 75E.

The composition unit 62E adjusts the noise included in the RAW image 75A2 for inference by combining the first image 75D and the second image 75E. That is, the image (the composite image 75F in the example shown in FIG. 7), which is obtained by combining the first image 75D and the second image 75E by the composition unit 62E, is an image in which the noise that is included in the RAW image 75A2 for inference is adjusted.

The composition unit 62E generates the composite image 75F by combining the first image 75D and the second image 75E according to the first weight 104 and the second weight 106. The composite image 75F is an image obtained by combining the pixel values between the first image 75D and the second image 75E for each pixel according to the first weight 104 and the second weight 106. Examples of the composite image 75F include a weighted average image obtained by performing a weighted average using the first weight 104 and the second weight 106. The weighted average using the first weight 104 and the second weight 106 refers to, for example, a weighted average using the first weight 104 and the second weight 106 for the pixel values for each pixel corresponding to the pixel positions between the first image 75D and the second image 75E. Note that, a weighted average image is only an example, and the image, which is obtained by performing a simple averaging of the pixel values without using the first weight 104 and the second weight 106, may be used as the composite image 75F in a case where an absolute value of a difference between the first weight 104 and the second weight 106 is less than a threshold value (for example, 0.01).

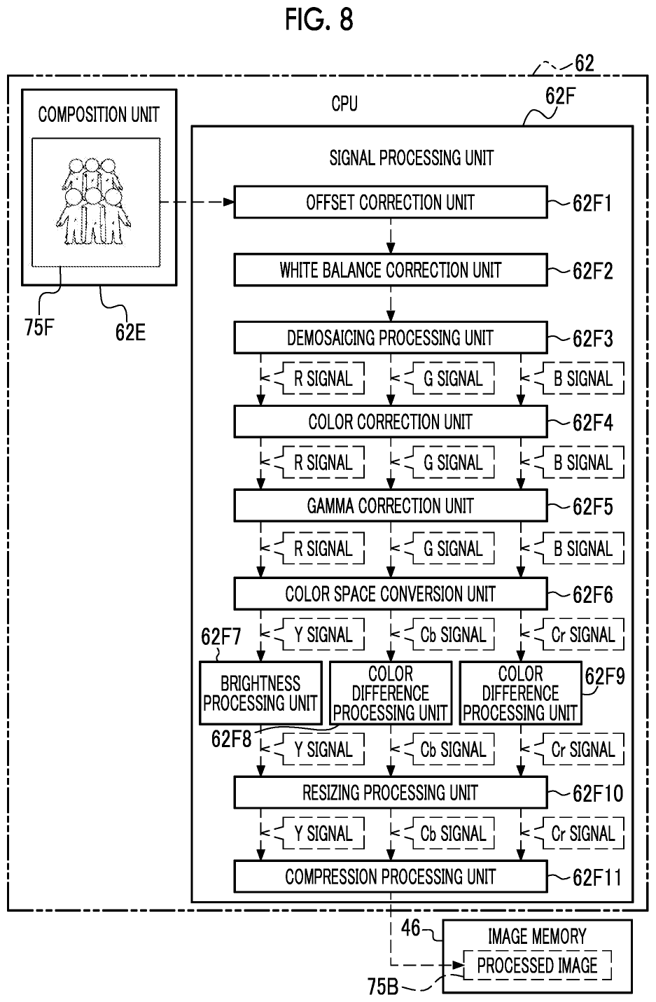

As an example shown in FIG. 8, the signal processing unit 62F includes an offset correction unit 62F1, a white balance correction unit 62F2, a demosaicing processing unit 62F3, a color correction unit 62F4, a gamma correction unit 62F5, a color space conversion unit 62F6, a brightness processing unit 62F7, a color difference processing unit 62F8, a color difference processing unit 62F9, a resizing processing unit 62F10, and a compression processing unit 62F11, and performs various signal processing on the composite image 75F.

The offset correction unit 62F1 performs offset correction processing on the composite image 75F. The offset correction processing is processing of correcting a dark current component included in the R pixel, the G pixel, and the B pixel included in the composite image 75F. Examples of the offset correction processing include processing of correcting the RGB color signal by subtracting an optical black signal value, which is obtained from the light-shielded photosensitive pixel included in the photoelectric conversion elements 72 (see FIG. 2), from the RGB color signal.

The white balance correction unit 62F2 performs the white balance correction processing on the composite image 75F on which the offset correction processing is performed. The white balance correction processing is processing of correcting the influence of the color of the light source type on the RGB color signal by multiplying the RGB color signal by the white balance gain that is set for each of the R pixel, G pixel, and B pixel. The white balance gain is, for example, a gain for white. Examples of the gain for white include a gain defined such that the signal levels of the R signal, the G signal, and the B signal are equal with respect to the white subject reflected in the composite image 75F. The white balance gain may be set according to, for example, the light source type that is specified by performing image analysis, or may be set according to the light source type that is designated by the user or the like.

The demosaicing processing unit 62F3 performs the demosaicing processing on the composite image 75F on which the white balance correction processing is performed. The demosaicing processing is processing of converting the composite image 75F into three plates of R, G, and B. That is, the demosaicing processing unit 62F3 generates R image data indicating an image corresponding to R, B image data indicating an image corresponding to B, and G image data indicating an image corresponding to G, by performing color interpolation processing on the R, G, and B signals. Here, the color interpolation processing refers to processing of interpolating color, in which each pixel does not have, from peripheral pixels. That is, since only the R signal, the G signal, or the B signal (that is, a pixel value of one color among R, G, and B) can be obtained in each photosensitive pixel of the photoelectric conversion elements 72, the demosaicing processing unit 62F3 interpolates other colors that cannot be obtained in each pixel by using the pixel values of the peripheral pixels. In the following, the R image data, the B image data, and the G image data are also referred to as “RGB image data”.

The color correction unit 62F4 performs color correction processing on the RGB image data obtained by performing the demosaicing processing (here, the color correction by a linear matrix (that is, mixture correction), as an example). The color correction processing is processing of adjusting the characteristics of the color tone and the color saturation. Examples of the color correction processing include processing of changing the color reproducibility by multiplying the RGB image data by a color reproduction coefficient (for example, a linear matrix coefficient). The color reproduction coefficient is a coefficient determined so as to bring the spectral characteristics of R, G, and B closer to the human visual sensitivity characteristics.

The gamma correction unit 62F5 performs gamma correction processing on the RGB image data in which the color correction processing is performed. The gamma correction processing is processing of correcting the gradation of an image indicated by the RGB image data according to a value indicating response characteristics of the gradation of the image, that is, the gamma value.

The color space conversion unit 62F6 performs color space conversion processing on the RGB image data in which the gamma correction processing is performed. The color space conversion processing is processing of converting the color space of the RGB image data, in which the gamma correction processing is performed, from the RGB color space to the YCbCr color space. That is, the color space conversion unit 62F6 converts the RGB image data into a brightness/color difference signal. The brightness/color difference signal is a Y signal, a Cb signal, and a Cr signal. The Y signal is a signal that indicates brightness. Hereinafter, the Y signal may be referred to as a brightness signal. The Cb signal is a signal obtained by adjusting a signal obtained by subtracting the brightness component from the B signal. The Cr signal is a signal obtained by adjusting a signal obtained by subtracting the brightness component from the R signal. Hereinafter, the Cb signal and the Cr signal may be referred to as a color difference signal.

The brightness processing unit 62F7 performs brightness filter processing on the Y signal. The brightness filter processing is processing of filtering the Y signal by using a brightness filter (not shown). For example, the brightness filter is a filter that reduces high-frequency noise generated by the demosaicing processing and emphasizes the sharpness. The signal processing with respect to the Y signal, that is, the filtering by the brightness filter, is performed according to a brightness filter parameter. The brightness filter parameter is a parameter set for the brightness filter. The brightness filter parameter defines the degree to which the high-frequency noise generated by the demosaicing processing is reduced and the degree to which the sharpness is emphasized. The brightness filter parameter is changed according to, for example, the related information 102 (see FIG. 6), the imaging condition, and/or the instruction received by the reception device 76.

The color difference processing unit 62F8 performs first color difference filter processing on the Cb signal. The first color difference filter processing is processing of filtering the Cb signal using a first color difference filter (not shown). For example, the first color difference filter is a low-pass filter that reduces the high-frequency noise included in the Cb signal. The signal processing with respect to the Cb signal, that is, the filtering by the first color difference filter is performed according to the designated a first color difference filter parameter. The first color difference filter parameter is a parameter set for the first color difference filter. The first color difference filter parameter defines the degree to which the high-frequency noise that is included in the Cb signal is reduced. The first color difference filter parameter is changed according to, for example, the related information 102 (see FIG. 6), the imaging condition, and/or the instruction received by the reception device 76.

The color difference processing unit 62F9 performs a second color difference filter processing on the Cr signal. The second color difference filter processing is processing of filtering the Cr signal by using a second color difference filter (not shown). For example, the second color difference filter is a low-pass filter that reduces the high-frequency noise included in the Cr signal. The signal processing with respect to the Cr signal, that is, the filtering by the second color difference filter is performed according to the designated a second color difference filter parameter. The second color difference filter parameter is a parameter set for the second color difference filter. The second color difference filter parameter defines the degree to which the high-frequency noise that is included in the Cr signal is reduced. The second color difference filter parameter is changed according to, for example, the related information 102 (see FIG. 6), the imaging condition, and/or the instruction received by the reception device 76.

The resizing processing unit 62F10 performs resizing processing on the brightness/color difference signal. The resizing processing is processing of adjusting the brightness/color difference signal such that the size of the image indicated by the brightness/color difference signal is adjusted to the size designated by the user or the like.

The compression processing unit 62F11 performs compression processing on the brightness/color difference signal in which the resizing processing is performed. The compression processing is, for example, processing of compressing the brightness/color difference signal according to a default compression method. Examples of the default compression method include JPEG, TIFF, JPEG XR, and the like. The processed image 75B is obtained by performing the compression processing on the brightness/color difference signal. The compression processing unit 62F11 stores the processed image 75B in the image memory 46.

Next, the operation of the imaging apparatus 10 will be described with reference to FIG. 9. FIG. 9 shows an example of a flow of the image quality adjustment processing executed by the CPU 62.

In the image quality adjustment processing shown in FIG. 9, first, in step ST100, the AI method processing unit 62A determines whether or not the RAW image 75A2 for inference (see FIG. 5) is generated by the image sensor 20 (see FIG. 2). In a case where the RAW image 75A2 for inference is not generated by the image sensor 20 in step ST100, the determination is set as negative, and the image quality adjustment processing shifts to step ST126. In a case where the RAW image 75A2 for inference is generated by the image sensor 20 in step ST100, the determination is set as positive, and the image quality adjustment processing shifts to step ST102.

In step ST102, the AI method processing unit 62A acquires the RAW image 75A2 for inference from the image sensor 20. Further, the non-AI method processing unit 62B also acquires the RAW image 75A2 for inference from the image sensor 20. After the processing in step ST102 is executed, the image quality adjustment processing shifts to step ST104.

In step ST104, the AI method processing unit 62A inputs the RAW image 75A2 for inference that is acquired in step ST102 to the trained NN 82. After the processing in step ST104 is executed, the image quality adjustment processing shifts to step ST106.

In step ST106, the weight applying unit 62D acquires the first image 75D output from the trained NN 82 by inputting the RAW image 75A2 for inference to the trained NN 82 in step ST104. After the processing in step ST106 is executed, the image quality adjustment processing shifts to step ST108.

In step ST108, the non-AI method processing unit 62B adjusts the noise included in the RAW image 75A2 for inference by using the non-AI method by filtering the RAW image 75A2 for inference, which is acquired in step ST102, by using the digital filter 100. After the processing in step ST108 is executed, the image quality adjustment processing shifts to step ST110.

In step ST110, the weight applying unit 62D acquires the second image 75E that is obtained by adjusting the noise included in the RAW image 75A2 for inference by using the non-AI method in step ST108. After the processing in step ST110 is executed, the image quality adjustment processing shifts to step ST112.

In step ST112, the weight derivation unit 62C acquires the related information 102 from the NVM 64. After the processing in step ST112 is executed, the image quality adjustment processing shifts to step ST114.

In step ST114, the weight derivation unit 62C extracts the sensitivity related information 102A from the related information 102 acquired in step ST112. After the processing in step ST114 is executed, the image quality adjustment processing shifts to step ST116.

In step ST116, the weight derivation unit 62C calculates the first weight 104 and the second weight 106 based on the sensitivity related information 102A extracted in step ST114. That is, the weight derivation unit 62C calculates the first weight 104 by specifying a value indicating the sensitivity of the image sensor 20 from the sensitivity related information 102A and substituting the value indicating the sensitivity of the image sensor 20 into the weight calculation expression 108, and calculates the second weight 106 from the calculated first weight 104. After the processing in step ST116 is executed, the image quality adjustment processing shifts to step ST118.

In step ST118, the weight applying unit 62D applies the first weight 104 calculated in step ST116 to the first image 75D acquired in step ST106. After the processing in step ST118 is executed, the image quality adjustment processing shifts to step ST120.

In step ST120, the weight applying unit 62D applies the second weight 106 calculated in step ST116 to the second image 75E acquired in step ST110. After the processing in step ST120 is executed, the image quality adjustment processing shifts to step ST122.

In step ST122, the composition unit 62E generates the composite image 75F by combining the first image 75D and the second image 75E according to the first weight 104 that is applied to the first image 75D in step ST118, and the second weight 106 that is applied to the second image 75E in step ST120. That is, the composition unit 62E generates the composite image 75F (for example, the weighted average image obtained by using the first weight 104 and the second weight 106) by combining the pixel values between the first image 75D and the second image 75E for each pixel according to the first weight 104 and the second weight 106. After the processing in step ST122 is executed, the image quality adjustment processing shifts to step ST124.

In step ST124, the signal processing unit 62F outputs the image, which is obtained by performing various signal processing (for example, the offset correction processing, the white balance correction processing, the demosaicing processing, the color correction processing, the gamma correction processing, the color space conversion processing, the brightness filter processing, the first color difference filter processing, the second color difference filter processing, the resizing processing, and the compression processing) on the composite image 75F obtained in step ST22, to a default output destination (for example, the image memory 46) s the processed image 75B. After the processing in step ST124 is executed, the image quality adjustment processing shifts to step ST126.

In step ST126, the signal processing unit 62F determines whether or not the condition for ending the image quality adjustment processing (hereinafter referred to as a “end condition”) is satisfied. Examples of the end condition include a condition that the reception device 76 receives an instruction of ending the image quality adjustment processing. In step ST126, in a case where the end condition is not satisfied, the determination is set as negative, and the image quality adjustment processing shifts to step ST100. In step ST126, in a case where the end condition is satisfied, the determination is set as positive, and the image quality adjustment processing is ended.

As described above, in the imaging apparatus 10, the first image 75D can be obtained by processing the RAW image 75A2 for inference by using the AI method using the trained NN 82. Further, in the imaging apparatus 10, the second image 75E can be obtained by processing the RAW image 75A2 for inference without using the AI method. Here, in a case where the noise that is included in the RAW image 75A is removed as the characteristics of the trained NN 82, there is a possibility that the microstructure is reduced accordingly. On the other hand, in the second image 75E, the microstructure that is reduced by the trained NN 82 from the RAW image 75A2 for inference also remains. Therefore, in the imaging apparatus 10, the composite image 75F is generated by combining the first image 75D and the second image 75E. As a result, it is possible to achieve both of the suppression of excess and deficiency of noise included in the image and the suppression of excess and deficiency of sharpness of the microstructure of the subject reflected in the image, as compared with the case where the image is processed by using only the AI method that uses the trained NN 82. Therefore, according to the present configuration, it is possible to obtain an image where the image quality is adjusted as compared with the case where the image is processed by using only the AI method that uses the trained NN 82.

Further, in the imaging apparatus 10, the noise is adjusted by combining the first image 75D, which is obtained by performing the AI method noise adjustment processing on the RAW image 75A2 for inference, and the second image 75E, which is obtained by processing the RAW image 75A2 for inference without using the AI method. Therefore, according to the present configuration, it is possible to obtain an image in which both the excessive noise and the disappearance of the microstructure are suppressed, as compared with the image in which only the AI method noise adjustment processing is performed, that is, the first image 75D.

Further, in the imaging apparatus 10, the noise is adjusted by combining the first image 75D, which is obtained by performing the AI method noise adjustment processing on the RAW image 75A2 for inference, and the second image 75E, which is obtained by performing the non-AI method noise adjustment processing on the RAW image 75A2 for inference. Therefore, according to the present configuration, it is possible to obtain an image in which both the excessive noise and the disappearance of the microstructure are suppressed, as compared with the image in which only the AI method noise adjustment processing is performed, that is, the first image 75D.

Further, in the imaging apparatus 10, the first weight 104 is applied to the first image 75D, and the second weight 106 is applied to the second image 75E. Thereafter, the first image 75D and the second image 75E are combined according to the first weight 104 that is applied to the first image 75D and the second weight that is applied to the second image 75E. Therefore, according to the present configuration, it is possible to obtain an image in which the degree of influence of the first image 75D and the degree of influence of the second image 75E with respect to the image quality are adjusted, as the composite image 75F.

Further, in the imaging apparatus 10, the first image 75D and the second image 75E are combined by performing the weighted average using the first weight 104 and the second weight 106. Therefore, according to the present configuration, it is possible to easily perform the composition of the first image 75D and the second image 75E, and perform the adjustment of the degree of influence of the first image 75D and the degree of influence of the second image 75E on the image quality of the composite image 75F, as compared with the case where the adjustment of the degree of influence of the first image 75D and the degree of influence of the second image 75E on the image quality of the image, which is obtained by combining after the composition of the first image 75D and the second image 75E, is performed.

Further, in the imaging apparatus 10, the first weight 104 and the second weight 106 are changed according to the related information 102. Therefore, according to the present configuration, it is possible to suppress the deterioration of the image quality due to the related information 102 as compared with the case where a certain weight, which is determined by relying only on the information completely irrelevant to the related information 102, is used.

Further, in the imaging apparatus 10, the first weight 104 and the second weight 106 are changed according to the sensitivity related information 102A included in the related information 102. Therefore, according to the present configuration, it is possible to suppress the deterioration of the image quality due to the sensitivity of the image sensor 20 as compared with the case where the constant weight, which is determined by relying only on information completely irrelevant to the sensitivity of the image sensor 20 used in the imaging for obtaining the RAW image 75A2 for inference, is used.

In the present embodiment, although the weight calculation expression 108 in which the first weight 104 is calculated from the value that indicates the sensitivity of the image sensor 20 is exemplified, the present disclosed technology is not limited to this, and a weight calculation expression in which the second weight 106 is calculated from the weight calculation expression 108 may be used. In this case, the first weight 104 is calculated from the second weight 106.

Further, although the weight calculation expression 108 is exemplified, the present disclosed technology is not limited to this, and a weight derivation table in which the value that indicates the sensitivity of the image sensor 20, and the first weight 104 or the second weight 106 are associated with each other may be used.

### FIRST MODIFICATION EXAMPLE

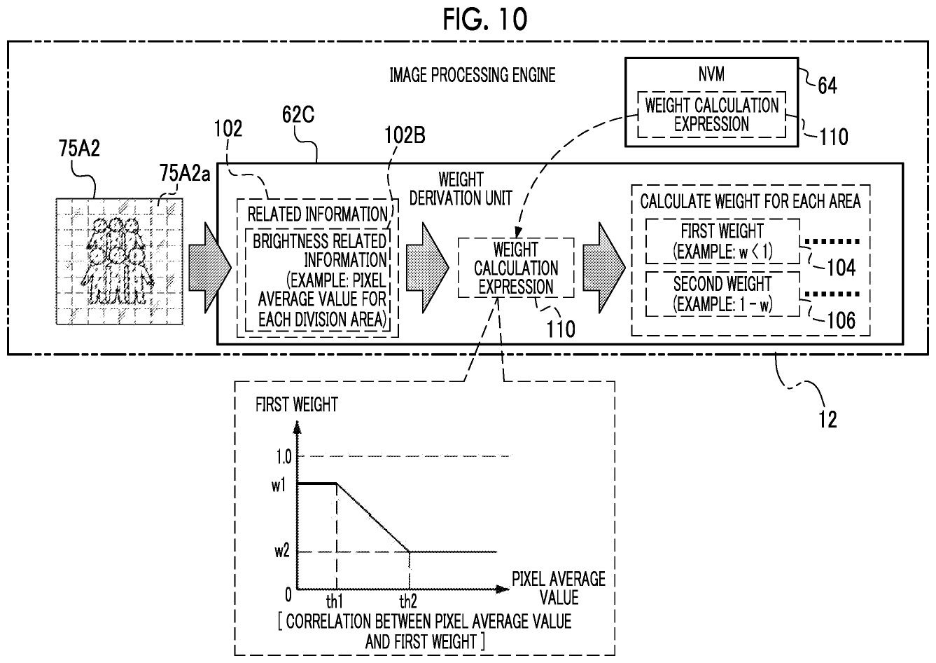

The trained NN 82 has a property that it is difficult to discriminate between the noise and the microstructure in a bright image region rather than in a dark image region. This property becomes more pronounced as a layer structure of the trained NN 82 is simplified. In this case, as an example shown in FIG. 10, the related information 102 may include brightness related information 102B related to the brightness of the RAW image 75A2 for inference, and the first weight 104 and the second weight 106 in accordance with the brightness related information 102B may be derived by the weight derivation unit 62C.

Examples of the brightness related information 102B include a pixel statistical value of at least a part of the RAW image 75A2 for inference. The pixel statistical value is, for example, a pixel average value.

In the example shown in FIG. 10, the RAW image 75A2 for inference is divided into a plurality of division areas 75A2a, and the related information 102 includes the pixel average value for each division area 75A2a. The pixel average value refers to, for example, an average value of the pixel values of all the pixels included in the division area 75A2a. The pixel average value is calculated by the CPU 62 each time the RAW image 75A2 for inference is generated, for example.

The weight calculation expression 110 is stored in the NVM 64. The weight derivation unit 62C acquires the weight calculation expression 110 from the NVM 64 and calculates the first weight 104 and the second weight 106 by using the acquired weight calculation expression 110.

The weight calculation expression 110 is a calculation expression in which the pixel average value is set to an independent variable and the first weight 104 is set to a dependent variable. The first weight 104 is changed according to the pixel average value. The correlation between the pixel average value and the first weight 104 indicated by the weight calculation expression 110 is, for example, that the first weight 104, in a case where the pixel average value is less than the threshold value th1, is a fixed value of “w1”. Further, the first weight 104, in a case where the pixel average value is more than the threshold value th2 (>th1), is a fixed value of “w2 w1)”. In a range, which is equal to or greater than the threshold value th1 and is equal to or less than the threshold value th2, the first weight 104 decreases as the pixel average value increases. In the example shown in FIG. 10, although the first weight is changed only between the threshold value th1 and the threshold value th2, this is only an example, and the weight calculation expression 110 may be any calculation expression defined such that the first weight 104 is changed according to the pixel average value regardless of the threshold values th1 and th2.

Further, the brighter the image region, the more difficult it is to distinguish between the noise and the microstructure, thereby it is preferable that the first weight 104 decreases as the pixel average value increases. This is because it is necessary in order to suppress the degree of influence of the pixel, which is uncertain whether the noise and the microstructure are discriminated, on the composite image 75F. In contrast to this, since the second weight 106 is “1−w”, the second weight 106 increases as the first weight 104 decreases. That is, as the first weight 104 decreases, the degree to which the second image 75E has an influence on the composite image 75F is greater than the degree to which the first image 75D has an influence on the composite image 75F.

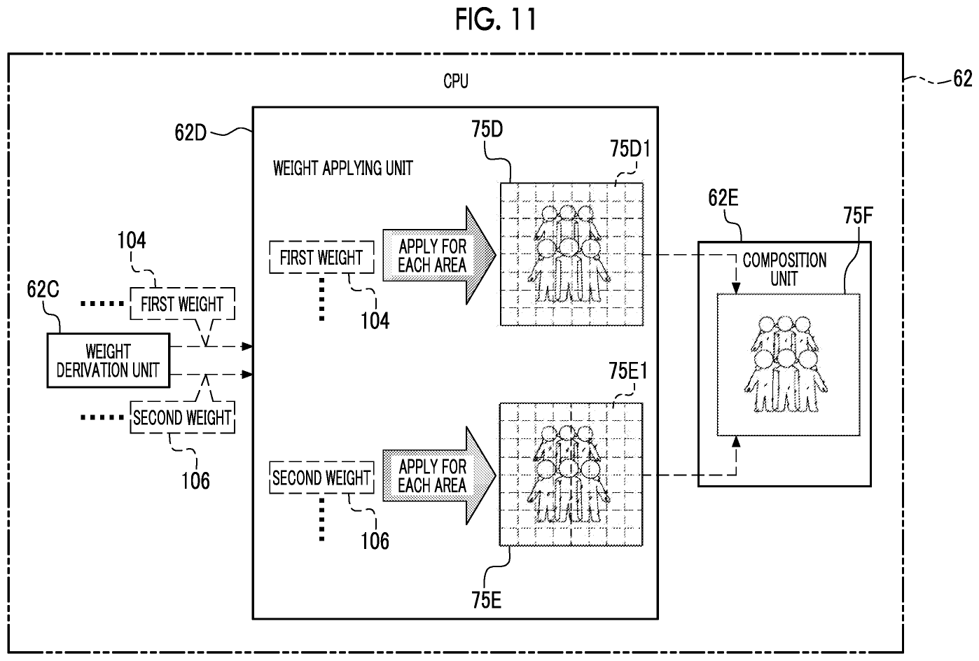

As an example shown in FIG. 11, the first image 75D is divided into a plurality of division areas 75D1, and the second image 75E is also divided into a plurality of division areas 75E1. Positions of the plurality of division areas 75D1 in the first image 75D correspond to positions of the plurality of division areas 75A2a in the RAW image 75A2 for inference, and positions of the plurality of division areas 75E1 in the second image 75E also correspond to position of the plurality of division areas 75A2a in the RAW image 75A2 for inference.

The weight applying unit 62D applies the first weight 104, which is calculated by the weight derivation unit 62C for the division areas 75A2a where the positions thereof correspond to the positions of the division areas 75D1, to each division area 75D1. Further, the weight applying unit 62D applies the second weight 106, which is calculated by the weight derivation unit 62C for the division areas 75A2a where the positions thereof correspond to the positions of the division areas 75E1, to each division area 75E1.

The composition unit 62E generates the composite image 75F by combining the division areas 75D1 and the division areas 75E1 where the positions correspond to each other according to the first weight 104 and the second weight 106. Similar to the above embodiment, the composition of the division areas 75D1 and the division areas 75E1 according to the first weight 104 and the second weight 106 is implemented by, for example, the weighted average by using the first weight 104 and the second weight 106, that is the weighted average for each pixel between the division area 75D1 and the division area 75E1.

As described above, in the present first modification example, the related information 102 includes brightness related information 102B related to the brightness of the RAW image 75A2 for inference, and the first weight 104 and the second weight 106 in accordance with the brightness related information 102B are derived by the weight derivation unit 62C. Therefore, according to the present configuration, it is possible to suppress the deterioration of the image quality due to the brightness of the RAW image 75A2 for inference as compared with the case where a certain weight, which is determined by relying only on the information completely irrelevant to the brightness of the RAW image 75A2 for inference, is used.

Further, in the first modification example, the pixel average value of each division area 75A2a of the RAW image 75A2 for inference is used as the brightness related information 102B. Therefore, according to the present configuration, it is possible to suppress the deterioration of the image quality due to the pixel statistical value related to the RAW image 75A2 for inference, as compared with the case where a certain weight, which is determined by relying only on the information completely irrelevant to the pixel statistical value related to the RAW image 75A2 for inference, is used.

In the present first modification example, although an example of the embodiment in which the first weight 104 and the second weight 106 are derived according to the pixel average value for each division area 75A2a has been described, the present disclosed technology is not limited to this, and the first weight 104 and the second weight 106 may be derived according to the pixel average value for each frame of the RAW image 75A2 for inference, and the first weight 104 and the second weight 106 may be derived according to the pixel average value of a part of the RAW image 75A2 for inference. Further, the first weight 104 and the second weight 106 may be derived according to the brightness of each pixel of the RAW image 75A2 for inference.

Further, in the present first modification example, although the weight calculation expression 110 is exemplified, the present disclosed technology is not limited to this, and a weight derivation table in which a plurality of pixel average values and a plurality of first weights 104 are associated with each other may be used.

Further, in the present first modification example, although the pixel average value is exemplified, this is only an example, and a pixel median value may be used or a pixel mode value may be used instead of the pixel average value.

### SECOND MODIFICATION EXAMPLE

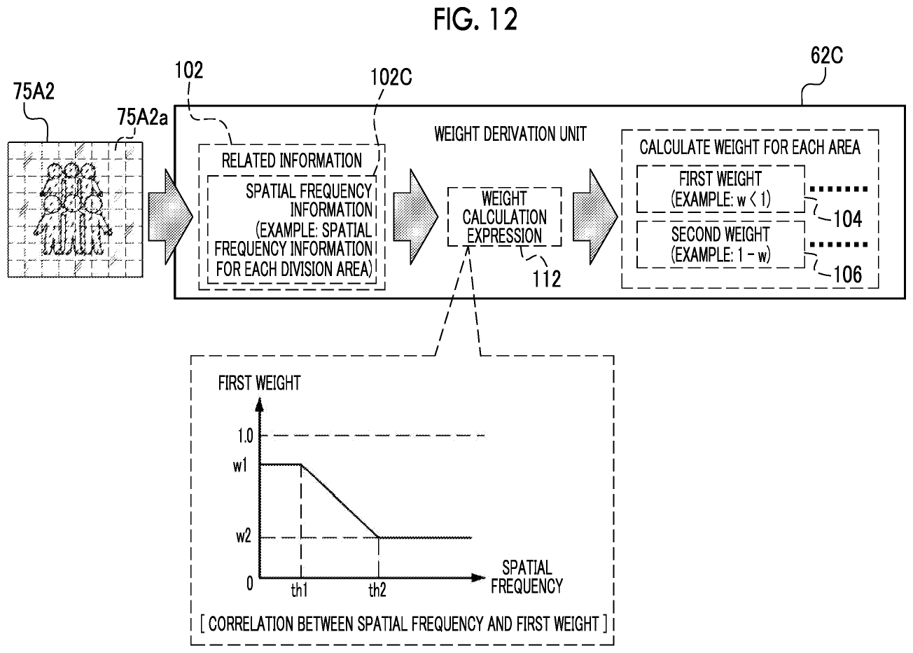

The trained NN 82 has a property that it is difficult to discriminate between the noise and the microstructure in an image region having high-frequency components rather than an image region having low-frequency components. This property becomes more pronounced as a layer structure of the trained NN 82 is simplified. In this case, as an example shown in FIG. 12, the related information 102 may include spatial frequency information 102C, which indicates the spatial frequency, of the RAW image 75A2 for inference, and the first weight 104 and the second weight 106 in accordance with the spatial frequency information 102C may be derived by the weight derivation unit 62C.

Compared to the example shown in FIG. 10, the example shown in FIG. 12 is different in that the spatial frequency information 102C is applied for each division area 75A2a instead of the pixel average value for each division area 75A2a, and is different in that the weight calculation expression 112 is applied instead of the weight calculation expression 110. The spatial frequency information 102C for each division area 75A2a is calculated by the CPU 62 each time, for example, the RAW image 75A2 for inference is generated.

The weight calculation expression 112 is a calculation expression in which the spatial frequency information 102C is set to an independent variable and the first weight 104 is set to a dependent variable. The first weight 104 is changed according to the spatial frequency information 102C. Further, the higher the spatial frequency, which is indicated by the spatial frequency information 102C, the more difficult it is to distinguish between the noise and the microstructure, thereby it is preferable that the first weight 104 decreases as the spatial frequency, which is indicated by the spatial frequency information 102C, increases regarding the first weight 104 on the spatial frequency information 102C. This is because it is necessary in order to suppress the degree of influence of the pixel, which is uncertain whether the noise and the microstructure are discriminated, on the composite image 75F. In contrast to this, since the second weight 106 is “1−w”, the second weight 106 increases as the first weight 104 decreases. That is, as the first weight 104 decreases, the degree to which the second image 75E has an influence on the composite image 75F is greater than the degree to which the first image 75D has an influence on the composite image 75F. The method of generating the composite image 75F is as described in the first modification example.

As described above, in the present second modification example, the related information 102 includes the spatial frequency information 102C indicating the spatial frequency of the RAW image 75A2 for inference, and the first weight 104 and the second weight 106 in accordance with the spatial frequency information 102C are derived by the weight derivation unit 62C. Therefore, according to the present configuration, it is possible to suppress the deterioration of the image quality due to the spatial frequency of the RAW image 75A2 for inference as compared with the case where a certain weight, which is determined by relying only on the information completely irrelevant to the spatial frequency of the RAW image 75A2 for inference, is used.

In the present second modification example, although an example of the embodiment in which the first weight 104 and the second weight 106 are derived according to the spatial frequency information 102C for each division area 75A2a has been described, the present disclosed technology is not limited to this, and the first weight 104 and the second weight 106 may be derived according to the spatial frequency information 102C for each frame of the RAW image 75A2 for inference, and the first weight 104 and the second weight 106 may be derived according to the spatial frequency information 102C of a part of the RAW image 75A2 for inference.

Further, in the present second modification example, although the weight calculation expression 112 is exemplified, the present disclosed technology is not limited to this, and a weight derivation table in which a plurality of spatial frequency information 102C and the plurality of first weights 104 are associated with each other may be used.

### THIRD MODIFICATION EXAMPLE

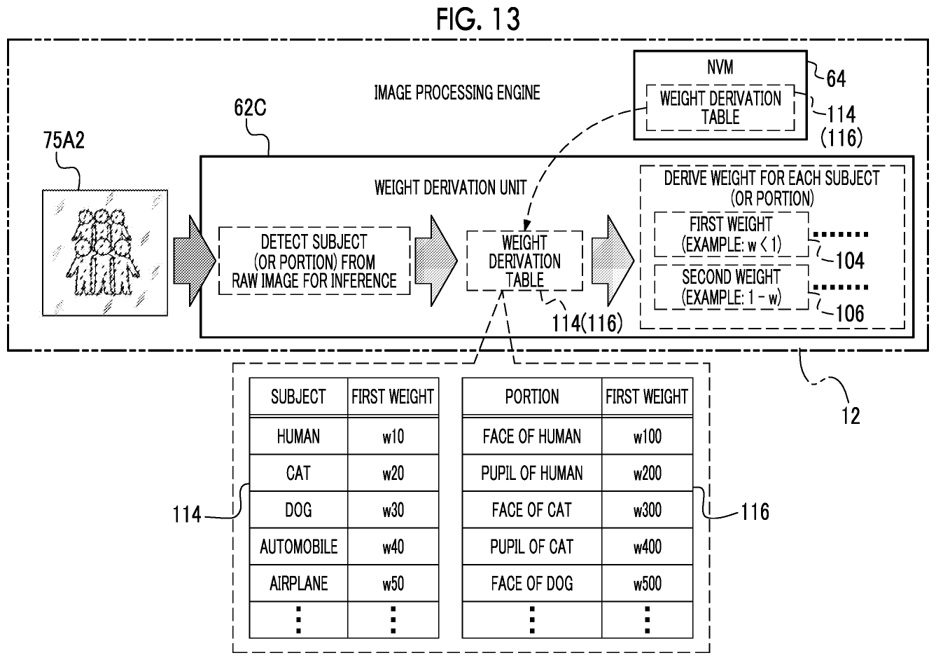

The CPU 62 may detect the subject reflected in the RAW image 75A2 for inference based on the RAW image 75A2 for inference and change the first weight 104 and the second weight 106 according to the detected subject. In this case, as an example shown in FIG. 13, the weight derivation table 114 is stored in the NVM 64, and the weight derivation unit 62C reads the weight derivation table 114 from the NVM 64 and derives the first weight 104 and the second weight 106 with reference to the weight derivation table 114. The weight derivation table 114 is a table in which a plurality of subjects and the plurality of first weights 104 are associated with each other on a one-to-one basis.

The weight derivation unit 62C has a subject detection function. The weight derivation unit 62C detects the subject that is reflected in the RAW image 75A2 for inference by operating the subject detection function. The detection of the subject may be an AI method detection or a non-AI method detection (for example, detection by the template matching).

The weight derivation unit 62C derives the first weight 104 corresponding to the detected subject from the weight derivation table 114 and calculates the second weight 106 from the derived first weight 104. Since different first weights 104 are associated with each of the subjects in the weight derivation table 114, the first weight 104 that is applied to first image 75D and the second weight 106 that is applied to the second image 75E are changed according to the subject detected from the RAW image 75A2 for inference.

The weight applying unit 62D may apply the first weight 104 only to the image region that indicates the subject detected by the weight derivation unit 62C in the entire image region of the first image 75D and may apply the second weight 106 only to the image region that indicates the subject detected by the weight derivation unit 62C in the entire image region of the second image 75E. Thereafter, the composition processing according to the first weight 104 and the second weight 106 may be performed only for the image region to which the first weight 104 is applied and the image region to which the second weight 106 is applied. However, this is only an example, the first weight 104 may be applied to the entire image region of the first image 75D, the second weight 106 may be applied to the entire image region of the second image 75E, and the composition processing according to the first weight 104 and the second weight 106 may be performed on the entire image region of the first image 75D and the entire image region of the second image 75E.

As described above, in the present third modification example, the subject that is reflected in the RAW image 75A2 for inference is detected, and the first weight 104 and the second weight 106 are changed according to the detected subject. Therefore, according to the present configuration, it is possible to suppress the deterioration of the image quality due to the subject reflected in the RAW image 75A2 for inference as compared with the case where a certain weight, which is determined by relying only on the information completely irrelevant to the subject reflected in the RAW image 75A2 for inference, is used.

### FOURTH MODIFICATION EXAMPLE

The CPU 62 may detect a portion of the subject reflected in the RAW image 75A2 for inference based on the RAW image 75A2 for inference and change the first weight 104 and the second weight 106 according to the detected portion. In this case, as an example shown in FIG. 13, the weight derivation table 116 is stored in the NVM 64, and the weight derivation unit 62C reads the weight derivation table 116 from the NVM 64 and derives the first weight 104 and the second weight 106 with reference to the weight derivation table 116. The weight derivation table 116 is a table in which a plurality of portions of the subject and the plurality of first weights 104 are associated with each other on a one-to-one basis.

The weight derivation unit 62C has a subject portion detection function. The weight derivation unit 62C detects the portion of the subject (for example, the face of a person and/or the pupil of a person) reflected in the RAW image 75A2 for inference by operating the subject portion detection function. The detection of the portion of the subject may be an AI method detection or a non-AI method detection (for example, detection by the template matching).

The weight derivation unit 62C derives the first weight 104 corresponding to the detected portion of the subject from the weight derivation table 116 and calculates the second weight 106 from the derived first weight 104. Since different first weights 104 are associated with each of the portions of the subject in the weight derivation table 114, the first weight 104 that is applied to first image 75D and the second weight 106 that is applied to the second image 75E are changed according to the portion of the subject detected from the RAW image 75A2 for inference.

The weight applying unit 62D may apply the first weight 104 only to the image region that indicates the portion of the subject detected by the weight derivation unit 62C in the entire image region of the first image 75D and may apply the second weight 106 only to the image region that indicates the portion of the subject detected by the weight derivation unit 62C in the entire image region of the second image 75E. Thereafter, the composition processing according to the first weight 104 and the second weight 106 may be performed only for the image region to which the first weight 104 is applied and the image region to which the second weight 106 is applied. However, this is only an example, the first weight 104 may be applied to the entire image region of the first image 75D, the second weight 106 may be applied to the entire image region of the second image 75E, and the composition processing according to the first weight 104 and the second weight 106 may be performed on the entire image region of the first image 75D and the entire image region of the second image 75E.

As described above, in the present fourth modification example, the portion of the subject that is reflected in the RAW image 75A2 for inference is detected, and the first weight 104 and the second weight 106 are changed according to the detected portion of the subject. Therefore, according to the present configuration, it is possible to suppress the deterioration of the image quality due to the portion of the subject reflected in the RAW image 75A2 for inference, as compared with the case where a certain weight, which is determined by relying only on the information completely irrelevant to the portion of the subject reflected in the RAW image 75A2 for inference, is used.

### FIFTH MODIFICATION EXAMPLE

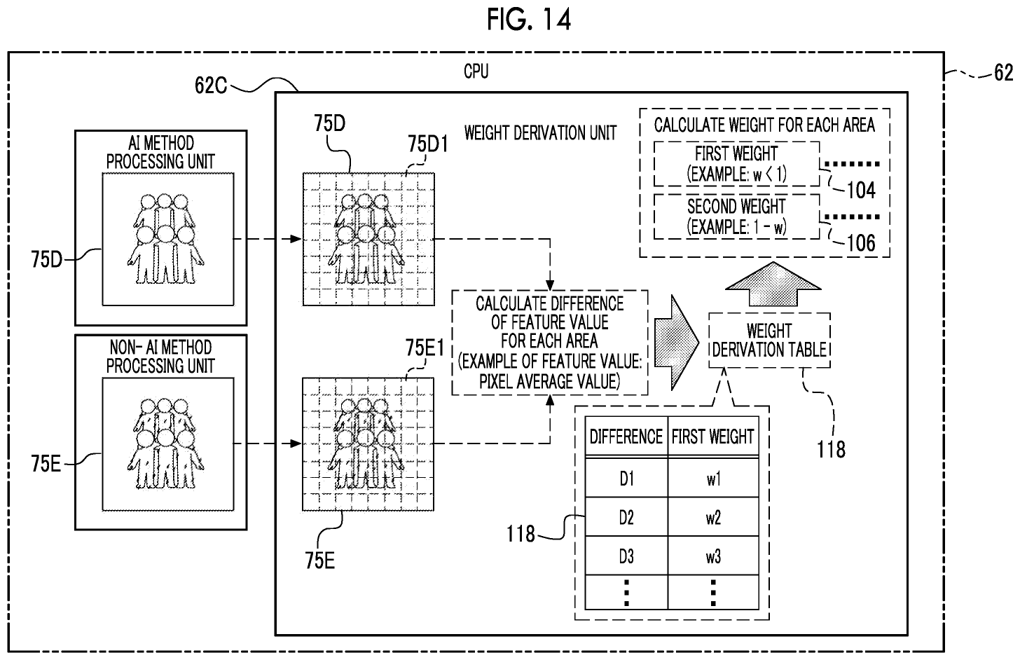

The CPU 62 may change the first weight 104 and the second weight 106 according to the degree of difference between a feature value of the first image 75D and a feature value of the second image 75E. As an example shown in FIG. 14, the weight derivation unit 62C calculates the pixel average value for each division area 75D1 of the first image 75D as the feature value of the first image 75D and calculates the pixel average value for each division area 75E1 of the second image 75E as the feature value of the second image 75E. The weight derivation unit 62C calculates a difference of the pixel average values (hereafter, also simply referred to as a “difference”), as the degree of difference between the feature value of the first image 75D and the feature value of the second image 75E, for each of the division areas 75D1 and 75E1 whose positions correspond to each other.

The weight derivation unit 62C derives the first weight 104 with reference to the weight derivation table 118. In the weight derivation table 118, a plurality of differences and the plurality of first weights 104 are associated with each other on a one-to-one basis. The weight derivation unit 62C derives the first weight 104 that corresponds to the calculated difference for each of the division areas 75D1 and 75E1 from the weight derivation table 118 and calculates the second weight 106 from the derived first weight 104. Since different first weights 104 are associated with each of the differences in the weight derivation table 118, the first weight 104 that is applied to first image 75D and the second weight 106 that is applied to the second image 75E are changed according to the difference.

As described above, in the fifth modification example, the first weight 104 and the second weight 106 are changed according to the degree of difference between the feature value of the first image 75D and the feature value of the second image 75E. Therefore, according to the present configuration, it is possible to suppress the deterioration of the image quality due to the degree of difference between the feature value of the first image 75D and the feature value of the second image 75E, as compared with the case where a certain weight, which is determined by relying only on the information completely irrelevant to the degree of difference between the feature value of the first image 75D and the feature value of the second image 75E, is used.

In the present fifth modification example, although the example of the embodiment in which the difference in the pixel average value is calculated for each of the division areas 75D1 and 75E1 has been described, the present disclosed technology is not limited to this, and the difference in the pixel average value may be calculated for each frame, or the difference in the pixel value may be calculated for each pixel.

Further, in the fifth modification example, although the pixel average value is exemplified as the feature value of the first image 75D and the feature value of the second image 75E, the present disclosed technology is not limited to this, and the pixel median value, the pixel mode value, or the like may be used.

Further, in the fifth modification example, although the weight derivation table 118 is exemplified, the present disclosed technology is not limited to this, and the calculation expression in which the difference is set to an independent variable and the first weight 104 is set to a dependent variable may be used.

### SIXTH MODIFICATION EXAMPLE

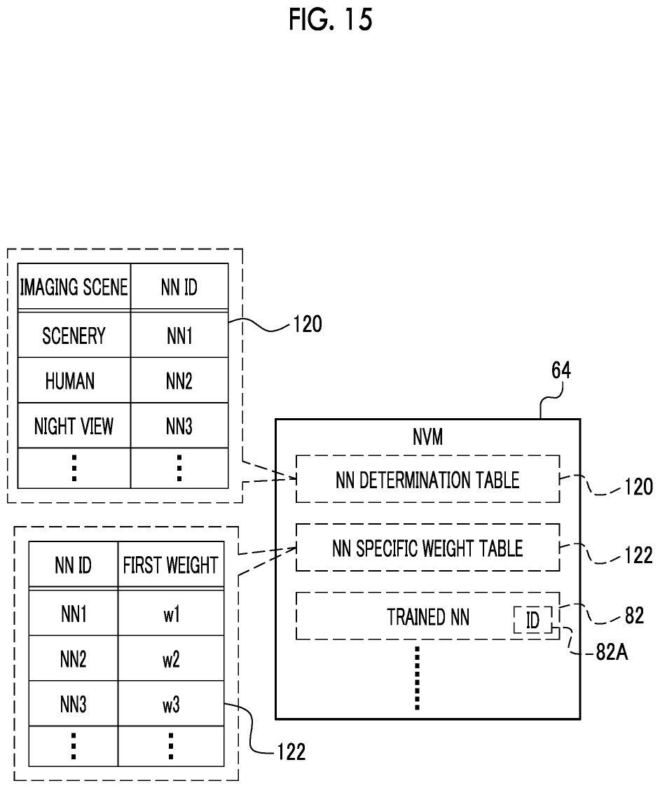

The trained NN 82 may be provided for each imaging scene. In this case, as an example shown in FIG. 15, a plurality of trained NNs 82 are stored in the NVM 64. The trained NN 82 in the NVM 64 is created for each imaging scene. An ID 82A is assigned to each trained NN 82. ID 82A is an identifier that is capable of specifying the trained NN 82. The CPU 62 switches the trained NN 82 to be used for each imaging scene and changes the first weight 104 and the second weight 106 according to the trained NN 82 to be used.

In the example shown in FIG. 15, an NN determination table 120 and an NN specific weight table 122 are stored in the NVM 64. In the NN determination table 120, a plurality of imaging scenes and a plurality of IDs 82A are associated with each other on a one-to-one basis. In the NN specific weight table 122, a plurality of IDs 82A and a plurality of first weights 104 are associated with each other on a one-to-one basis.

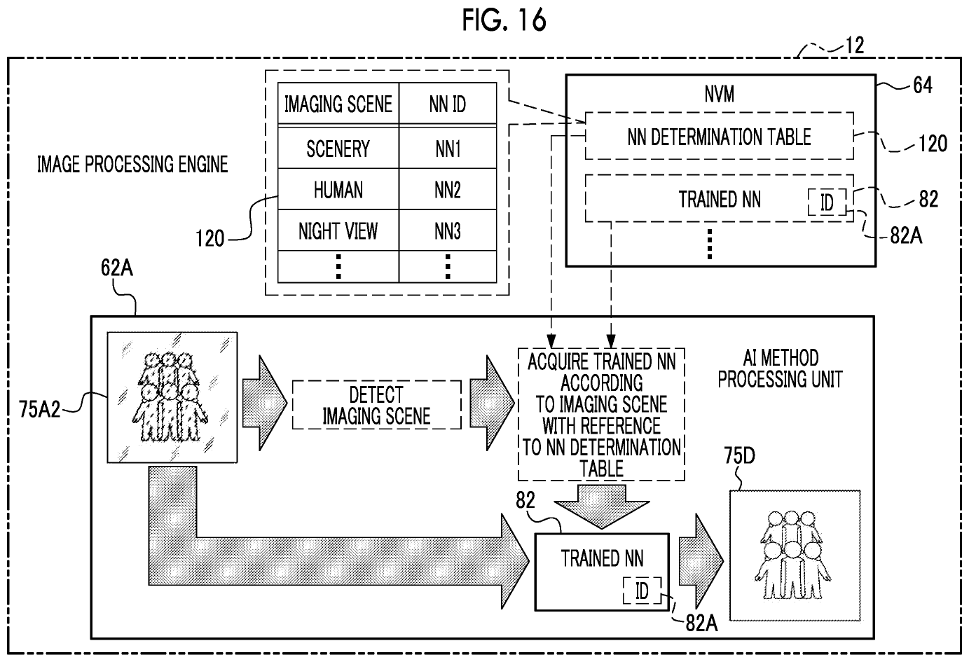

As an example shown in FIG. 16, the AI method processing unit 62A has an imaging scene detection function. The AI method processing unit 62A detects the scene that is reflected in the RAW image 75A2 for inference as the imaging scene by operating the imaging scene detection function. The detection of the imaging scene may be an AI method detection or a non-AI method detection (for example, detection by the template matching). The imaging scene may be determined according to the instruction received by the reception device 76.

The AI method processing unit 62A derives the ID 82A that corresponds to the detected imaging scene from the NN determination table 120 and acquires the trained NN 82 specified from the derived ID 82A from the NVM 64. Thereafter, the AI method processing unit 62A acquires the first image 75D by inputting the RAW image 75A2 for inference, which is the detection target of the imaging scene, in the trained NN 82.

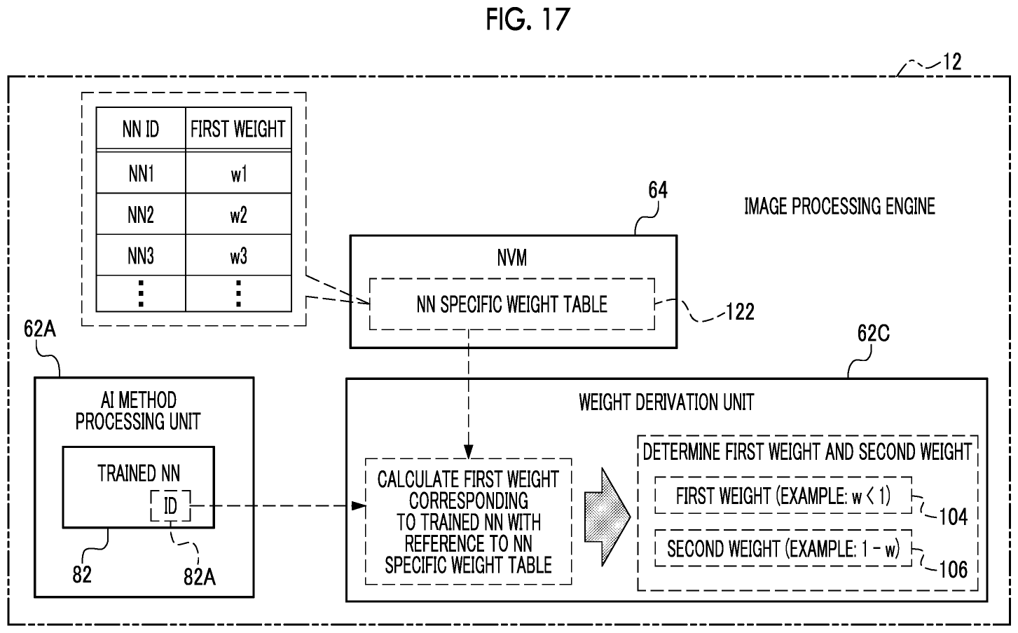

As an example shown in FIG. 17, the weight derivation unit 62C derives the first weight 104, which corresponds to the ID 82A of the trained NN 82 used in the AI method processing unit 62A, from the NN specific weight table 122 and calculates the second weight 106 from the derived first weight 104. Since different first weights 104 are associated with each of the IDs 82A in the NN specific weight table 122, the first weight 104 that is applied to first image 75D and the second weight 106 that is applied to the second image 75E are changed according to the trained NN 82 used in the AI method processing unit 62A.

In the present sixth modification example, the trained NN 82 is provided for each imaging scene, and the trained NN 82 that is used by the AI method processing unit 62A is switched for each imaging scene. Thereafter, the first weight 104 and the second weight 106 are changed according to the trained NN 82 used in the AI method processing unit 62A. Therefore, according to the present configuration, it is possible to suppress deterioration of the image quality as the trained NN 82 is switched for each imaging scene as compared with the case where a constant weight is used constantly even in a case where the trained NN 82 is switched for each imaging scene.

In the present sixth modification example, although the NN determination table 120 and the NN specific weight table 122 are defined as separate tables, the tables may be combined into one table. In this case, for example, it may be a table in which the ID 82A and the first weight 104 are associated with each other on a one-to-one basis for each imaging scene.

### SEVENTH MODIFICATION EXAMPLE

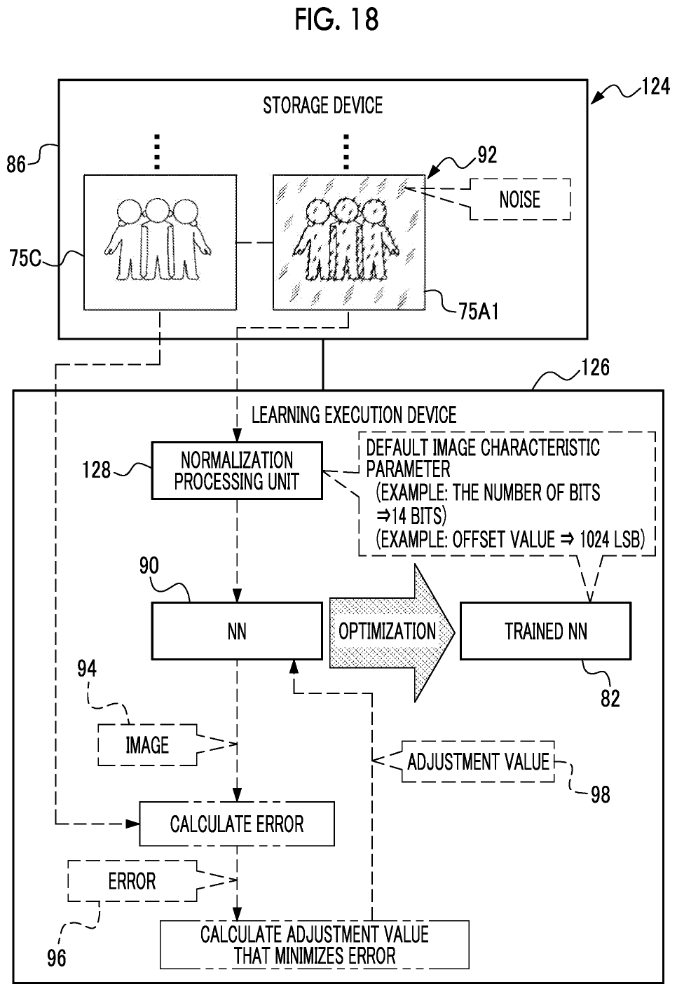

The CPU 62 may normalize the RAW image 75A2 for inference that is input to the trained NN 82 with respect to a default image characteristic parameter. The image characteristic parameter is a parameter determined according to the image sensor 20 and the imaging condition, which are used for the imaging for obtaining the RAW image 75A2 for inference input to the trained NN 82. In the present seventh modification example, as an example shown in FIG. 18, the image characteristic parameter is the number of bits of each pixel (hereinafter, also referred to as “the number of image characteristic bits”) and an offset value related to an optical black (hereinafter, also referred to as an “OB offset value”). For example, the number of image characteristic bits is 14 bits, and the OB offset value is 1024 LSB.

As an example shown in FIG. 18, the learning execution system 124 is different from the learning execution system 84 shown in FIG. 4 in that the learning execution device 126 is applied instead of the learning execution device 88. The learning execution device 126 is different from the learning execution device 88 in that a normalization processing unit 128 is included.

The normalization processing unit 128 acquires a RAW image 75A1 for learning from the storage device 86 and normalizes the acquired RAW image 75A1 for learning with respect to the image characteristic parameter. For example, the normalization processing unit 128 adjusts the number of image characteristic bits of the RAW image 75A1 for learning acquired from the storage device 86 to 14 bits and adjusts the OB offset value of the RAW image 75A1 for learning to 1024 LSB. The normalization processing unit 128 inputs the RAW image 75A1 for learning, which is normalized with respect to the image characteristic parameter, to the NN 90. As a result, the trained NN 82 is generated as in the example shown in FIG. 4. The image characteristic parameters used for the normalization, that is the number of image characteristic bits (14 bits) and the OB offset value (1024 LSB) are associated with the trained NN 82. The number of image characteristic bits (14 bits) and the OB offset value (1024 LSB) are examples of a “first parameter” according to the present disclosed technology. Hereinafter, for convenience of explanation, in a case where it is not necessary to distinguish between the number of image characteristic bits and the OB offset value, which are associated with the trained NN 82, the number of image characteristic bits and the OB offset value are referred to as the first parameter.

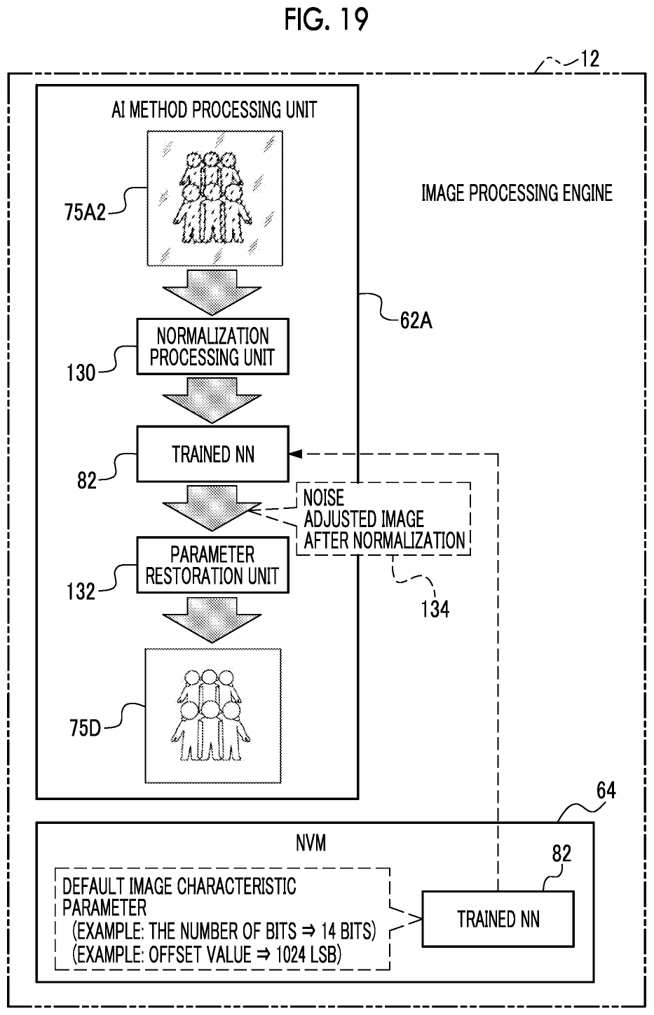

As an example shown in FIG. 19, the AI method processing unit 62A has a normalization processing unit 130 and a parameter restoration unit 132. The normalization processing unit 130 normalizes the RAW image 75A2 for inference by using the first parameter and second parameters, which are the number of image characteristic bits and the OB offset value of the RAW image 75A2 for inference.

In the present seventh modification example, the imaging apparatus 10 is an example of a “first imaging apparatus” and a “second imaging apparatus” according to the present disclosed technology. Further, the RAW image 75A1 for learning normalized by the normalization processing unit 128 is an example of an “image for learning” according to the present disclosed technology. Further, the RAW image 75A1 for learning is an example of a “first RAW image” according to the present disclosed technology. Further, the RAW image 75A2 for inference is an example of an “image for inference” and a “second RAW image” according to the present disclosed technology.

The normalization processing unit 130 normalizes the RAW image 75A2 for inference by using the following Formula (1). In Formula (1), “Bₜ” is the number of image characteristic bits associated with the trained NN 82, “Oₜ,” is an OB offset value associated with the trained NN 82, “Bᵢ” is the number of image characteristic bits of the RAW image 75A2 for inference, “Oᵢ,” is an OB offset value of the RAW image 75A2 for inference, “P₀” is a pixel value of the RAW image 75A2 for inference, and “P₁” is a pixel value after the normalization of the RAW image 75A2 for inference.

P₁=(P₀−Oᵢ)*2^{(B}^{ₜ}^{-B}^{ᵢ}⁾+Oₜ (1)

The normalization processing unit 130 inputs the RAW image 75A2 for inference, which is normalized by using Formula (1), to the trained NN 82. By inputting the RAW image 75A2 for inference to the trained NN 82, a noise adjusted image 134 after the normalization is output from the trained NN 82 as the first image 75D that is defined by the first parameter.

The parameter restoration unit 132 acquires the noise adjusted image 134 after the normalization. Thereafter, the parameter restoration unit 132 adjusts the noise adjusted image 134 after the normalization to the image of the second parameter by using the first parameter and the second parameter. That is, the parameter restoration unit 132 restores the number of image characteristic bits and the OB offset value before the normalization by the normalization processing unit 130 from the number of image characteristic bits and OB offset value of the noise adjusted image 134 after the normalization, by using the following Formula (2). The noise adjusted image 134 after the normalization, which is defined by the second parameter restored according to Formula (2), is used as an image to which the first weight 104 is applied. In Formula (2), “P₂” is a pixel value after the RAW image 75A2 for inference is restored to the number of image characteristic bits and the OB offset value before the normalization by the normalization processing unit 130.

P₂=(P₁−Oₜ)*2^{(B}^{ᵢ}^{-B}^{ₜ}⁾+Oᵢ (2)

As described above, in the present seventh modification example, the RAW image 75A2 for inference that is input to the trained NN 82 is normalized with respect to the default image characteristic parameter. Therefore, according to the present configuration, it is possible to suppress the deterioration of the image quality due to the difference in the image characteristic parameters of the RAW image 75A2 for inference that is input to the trained NN 82, as compared with the case where the RAW image 75A2 for inference, which is not normalized with respect to the image characteristic parameters, is input to the trained NN 82.

Further, in the present seventh modification example, as the image for learning that is input to the NN 90 in a case where the NN 90 is trained, the RAW image 75A1 for learning, which is normalized by the normalization processing unit 128 with respect to the image characteristic parameters, is used. Therefore, according to the present configuration, it is possible to suppress the deterioration of the image quality due to the difference in the image characteristic parameters for each RAW image 75A1 for learning that is input to the NN 90 as an image for learning, as compared with the case where the RAW image 75A1 for learning, which is not normalized with respect to the image characteristic parameters, is used as an image for learning of the NN 90.

Further, in the present seventh modification example, as the image for inference that is input to the trained NN 82, the RAW image 75A2 for inference that is normalized by the normalization processing unit 130 for the image characteristic parameter is used. Therefore, according to the present configuration, it is possible to suppress the deterioration of the image quality due to the difference in the image characteristic parameters of the RAW image 75A2 for inference that is input to the trained NN 82, as compared with the case where the RAW image 75A2 for inference, which is not normalized with respect to the image characteristic parameters, is used as the image for inference of the trained NN 82.

Further, in the seventh modification example, the image characteristic parameter of the noise adjusted image 134 after the normalization, which is output from the trained NN 82, is restored to the second parameter of the RAW image 75A2 for inference before the normalization by the normalization processing unit 130. Thereafter, the noise adjusted image 134 after the normalization, which is restored to the second parameter, is used as the first image 75D to be an applying target of the first weight 104. Therefore, according to the present configuration, it is possible to suppress deterioration of the image quality as compared with the case where the image characteristic parameter of the noise adjusted image 134 after the normalization is not restored to the second parameter of the RAW image 75A2 for inference before the normalization by the normalization processing unit 130.

In the present seventh modification example, although the example of the embodiment in which both the number of image characteristic bits and the OB offset value of the RAW image 75A1 for learning are normalized has been described, the present disclosed technology is not limited to this, and the number of image characteristic bits or the OB offset value of the RAW image 75A1 for learning may be normalized.

Further, in the present seventh modification example, although the example of the embodiment in which both the number of image characteristic bits and the OB offset value of the RAW image 75A2 for inference are normalized has been described, the present disclosed technology is not limited to this, and the number of image characteristic bits or the OB offset value of the RAW image 75A2 for inference may be normalized. Note that, it is preferable that the number of image characteristic bits of the RAW image 75A2 for inference is normalized in a case where the number of image characteristic bits of the RAW image 75A1 for learning is normalized in a learning step, and it is preferable that the OB offset value of the RAW image 75A2 for inference is normalized in a case where the OB offset value of the RAW image 75A1 for learning is normalized in the learning step.

Further, in the present seventh modification example, although the normalization is exemplified, this is only an example, and the weight that applies to the first image 75D and the second image 75E may be changed instead of the normalization.

Further, in the present seventh modification example, since the RAW image 75A2 for inference that is input to the trained NN 82 is normalized, even in a case where the plurality of RAW images 75A2 for inference having different image characteristic parameters are applied to one trained NN 82, it is possible to suppress deterioration of the image quality due to variations in image characteristic parameters, but the present disclosed technology is not limited to this. For example, the trained NN 82 may be stored in the NVM 64 for each image characteristic parameter. In this case, the trained NN 82 may be used properly according to the image characteristic parameter of the RAW image 75A2 for inference.

Further, in the present seventh modification example, although an example of the embodiment in which the RAW image 75A1 for learning is normalized by the normalization processing unit 128 has been described, the normalization of the RAW image 75A1 for learning is not essential. That is, in a case where all the RAW images 75A1 for learning that is input to the NN90 are images having constant image characteristic parameters (for example, the number of image characteristic bits is 14 bits and the OB offset value is 1024 LSB), the normalization processing unit 128 is unnecessary.

### EIGHTH MODIFICATION EXAMPLE

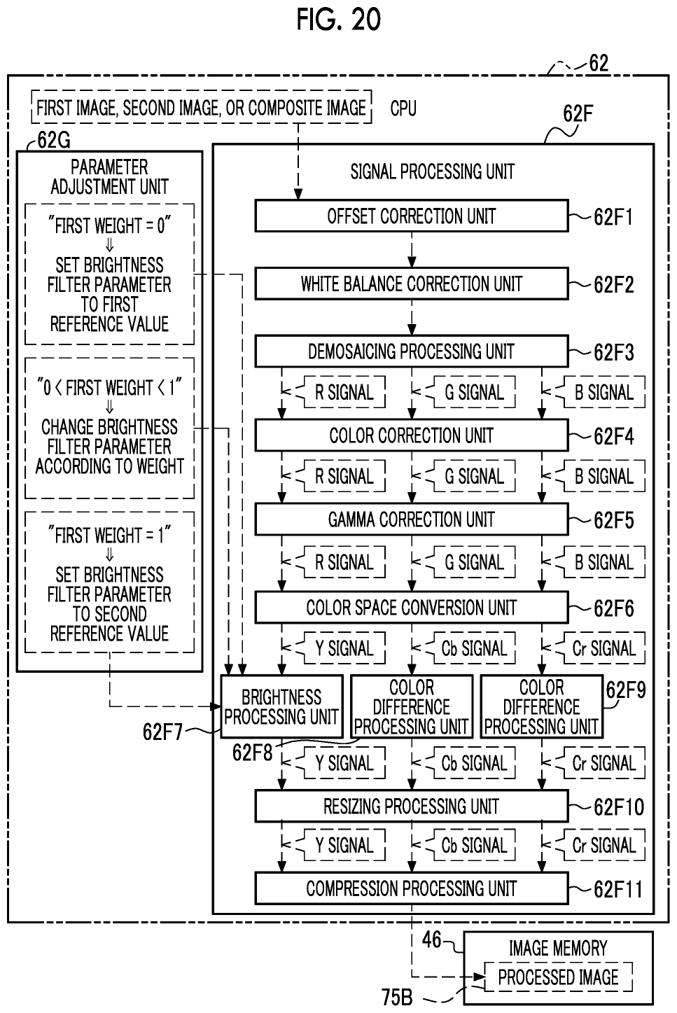

The CPU 62 performs the signal processing on the first image 75D and the second image 75E according to the designated set value, and the set value may be different between the case where the signal processing is performed on the first image 75D and the case where the signal processing is performed on the second image 75E. In this case, as an example shown in FIG. 20, the CPU 62 further includes a parameter adjustment unit 62G. The parameter adjustment unit 62G makes the brightness filter parameter, which is set for the brightness processing unit 62F7, different between the case where the signal processing is performed on the first image 75D by the signal processing unit 62F and the case where the signal processing is performed on the second image 75E by the signal processing unit 62F. The brightness filter parameter is an example of a “set value” according to the present disclosed technology.

The first image 75D, the second image 75E, and the composite image 75F are selectively input to the signal processing unit 62F. In order to selectively input the first image 75D, the second image 75E, and the composite image 75F to the signal processing unit 62F, for example, the CPU 62 may change the first weight 104. For example, in a case where the first weight 104 is “0”, only the second image 75E, among the first image 75D, the second image 75E, and the composite image 75F, is input to the signal processing unit 62F. Further, for example, in a case where the first weight 104 is “1”, only the first image 75D, among the first image 75D, the second image 75E, and the composite image 75F, is input to the signal processing unit 62F. Further, for example, in a case where the first weight 104 is greater than “0” and less than “1”, only the composite image 75F, among the first image 75D, the second image 75E, and the composite image 75F, is input to the signal processing unit 62F.

In a case where the first weight 104 is “0”, the parameter adjustment unit 62G sets the brightness filter parameter to a first reference value that is specialized for the brightness adjustment of the second image 75E. For example, the first reference value is a value capable of supplementing the sharpness disappeared from the second image 75E due to the characteristics of the digital filter 100 (see FIG. 5).

In a case where the first weight 104 is “1”, the parameter adjustment unit 62G sets the brightness filter parameter to a second reference value that is specialized for the brightness adjustment of the first image 75D. For example, the second reference value is a value capable of supplementing the sharpness disappeared from the first image 75D due to the characteristics of the trained NN 82 (see FIG. 7).

In a case where the first weight 104 is larger than “0” and less than “1”, as described in the above embodiment, the parameter adjustment unit 62G changes the brightness filter parameters according to the first weight 104 and the second weight 106 derived by the weight derivation unit 62C.

As described above, in the present eighth modification example, the brightness filter parameters are different between the case where the signal processing is performed on the first image 75D and the case where the signal processing is performed on the second image 75E. Therefore, according to the present configuration, it is possible to implement the sharpness suitable for the first image 75D influenced by the AI method noise adjustment processing and the sharpness suitable for the second image 75E not influenced by the AI method noise adjustment processing, as compared with the case where the filtering, which uses the brightness filter according to the same brightness filter parameter, is constantly performed on the Y signal of the first image 75D and the Y signal of the second image 75E.

Further, in the present eighth modification example, in a case where the first weight 104 is “1” and in a case where the first weight 104 is more than “0” and less than “1”, the filtering that uses the brightness filter is performed on the Y signal of the first image 75D obtained by the brightness processing unit 62F7 as processing of correcting the sharpness disappeared due to the AI method noise adjustment processing. Therefore, according to the present configuration, it is possible to obtain an image with high sharpness as compared with the case where the processing of correcting the sharpness disappeared due to the AI method noise adjustment processing is not performed on the first image 75D.

In the present eighth modification example, although an example of the embodiment in which the brightness filter parameters are different between the case where the signal processing is performed on the first image 75D and the case where the signal processing is performed on the second image 75E has been described, the present disclosed technology is not limited to this, and a parameter used in the offset correction processing, a parameter used in the white balance correction processing, a parameter used in the demosaicing processing, a parameter used in the color correction processing, a parameter used in the gamma correction processing, a first color difference filter parameter, a second color difference filter parameter, a parameter used in the resizing processing, and/or a parameter used in the compression processing may be different between the case where the signal processing is performed on the first image 75D and the case where the signal processing is performed on the second image 75E. Further, in a case where the signal processing unit 62F is provided with a sharpness correction processing unit (not shown) that performs sharpness processing of adjusting the sharpness of the image, the parameters (for example, parameters that are capable of adjusting the degree of emphasis on sharpness) used in the sharpness correction processing unit may be different between the case where the signal processing is performed on the first image 75D and the case where the signal processing is performed on the second image 75E.

### NINTH MODIFICATION EXAMPLE

The trained NN 82 has a property that it is difficult to discriminate between the noise and the microstructure in a bright image region rather than in a dark image region. This property becomes more pronounced as a layer structure of the trained NN 82 is simplified. In a case where it is difficult to distinguish between the noise and the microstructure in a bright image region than in a dark image region, the trained NN 82 discriminates the microstructure as noise and removes the microstructure, thereby it is expected that an image with lack of sharpness is obtained as the first image 75D. One of the causes of the lack of sharpness of the first image 75D is considered to be the lack of brightness forming the microstructure. This is because the brightness is more likely to be discriminated and removed as noise by the trained NN 82, even though the brightness contributes more to the formation of the microstructure than the color.

Therefore, in the present ninth modification example, the signal processing is performed on the first image 75D and the second image 75E such that the first image 75D and the second image 75E, which are set as composition targets in the composition processing, are converted into an image that is represented by a Y signal, a Cb signal, and a Cr signal, the weights of the Y signal of the second image 75E are made larger than the weights of the Y signal of the first image 75D, and the weights of the Cb signal and Cr of the first image are made larger than weights of the Cb signal and Cr signal of the second image 75E. Specifically, according to the first weight 104 and the second weight 106, the signal processing is performed on the first image 75D and the second image 75E such that the signal level of the Y signal of the second image 75E is made higher than that of the first image 75D, and the signal levels of the Cb signal and Cr signal of the first image 75D are made higher than those of the second image 75E.

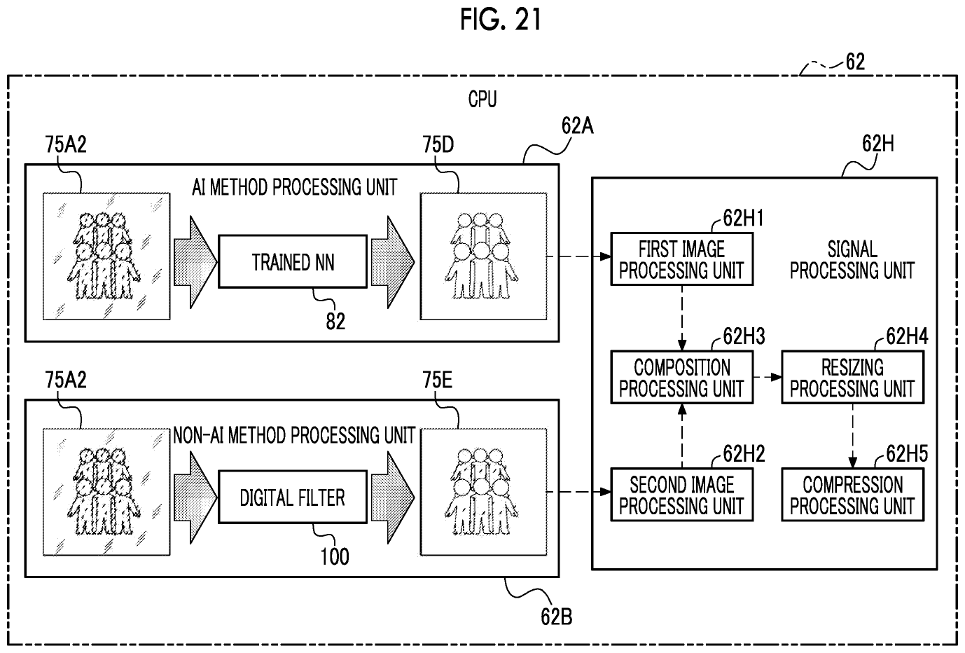

In this case, as an example shown in FIG. 21, the CPU 62 has a signal processing unit 62H instead of the composition unit 62E and the signal processing unit 62F described in the above embodiment. The signal processing unit 62H includes a first image processing unit 62H1, a second image processing unit 62H2, a composition processing unit 62H3, a resizing processing unit 62H4, and a compression processing unit 62H5. The first image processing unit 62H1 acquires the first image 75D from the AI method processing unit 62A and performs the signal processing on the first image 75D. The second image processing unit 62H2 acquires the second image 75E from the non-AI method processing unit 62B and performs the signal processing on the second image 75E. The composition processing unit 62H3 performs the composition processing in the same manner as the above-mentioned composition unit 62E. That is, the composition processing unit 62H3 generates the above-mentioned composite image 75F by combining the first image 75D in which the signal processing is performed by the first image processing unit 62H1 and the second image 75E in which the signal processing is performed by the second image processing unit 62H2. The resizing processing unit 62H4 performs the above-mentioned resizing processing on the composite image 75F generated by the composition processing unit 62H3. The compression processing unit 62H5 performs the above-mentioned compression processing on the composite image 75F in which the resizing processing is performed by the resizing processing unit 62H4. By performing the compression processing, the processed image 75B (see FIGS. 2, 8, and 20) is obtained as described above.

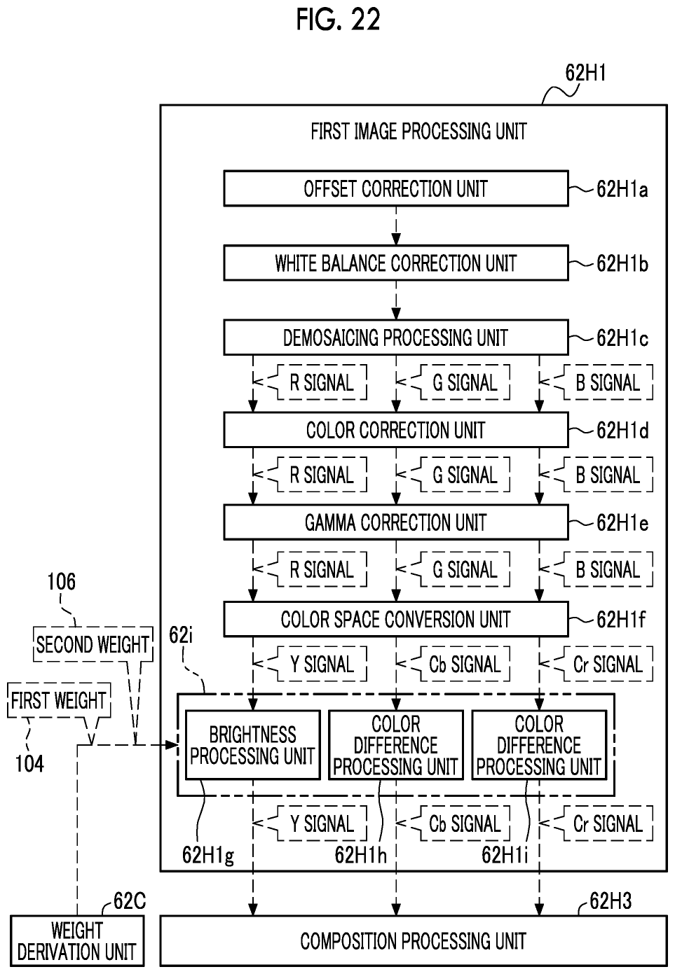

As an example shown in FIG. 22, the first image processing unit 62H1 includes an offset correction unit 62H1a, which has the same function as the offset correction unit 62F1 described above, a white balance correction unit 62H1b, which has the same function as the white balance correction unit 62F2 described above, a demosaicing processing unit 62H1c, which has the same function as the demosaicing processing unit 62F3 described above, a color correction unit 62H1d, which has the same function as the color correction unit 62F4 described above, a gamma correction unit 62H1e, which has the same function as the gamma correction unit 62F5 described above, a color space conversion unit 62H1f, which has the same function as the color space conversion unit 62F6 described above, and a weight applying unit 62i for first image. The weight applying unit 62i for first image includes a brightness processing unit 62H1g, which has the same function as the brightness processing unit 62F7 described above, a color difference processing unit 62H1h, which has the same function as the color difference processing unit 62F8 described above, and a color difference processing unit 62H1i, which has the same function as the color difference processing unit 62F9 described above.

In a case where the first image 75D is input from the AI method processing unit 62A to the first image processing unit 62H1 (see FIG. 21), the offset correction processing, the white balance processing, the demosaicing processing, the color correction processing, the gamma correction processing, and the color space conversion processing are sequentially performed on the first image 75D.

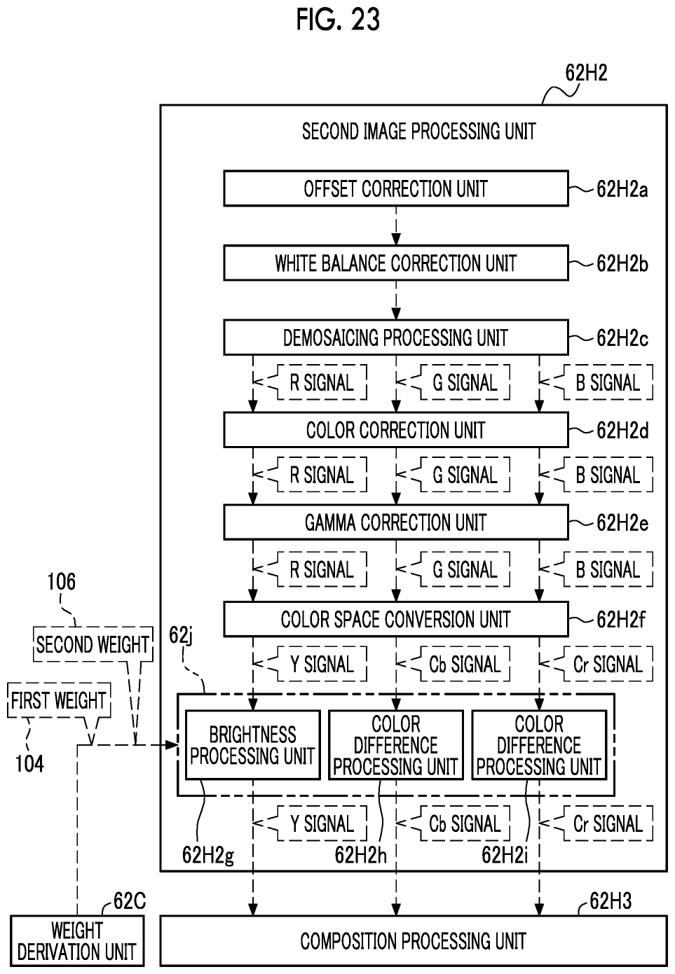

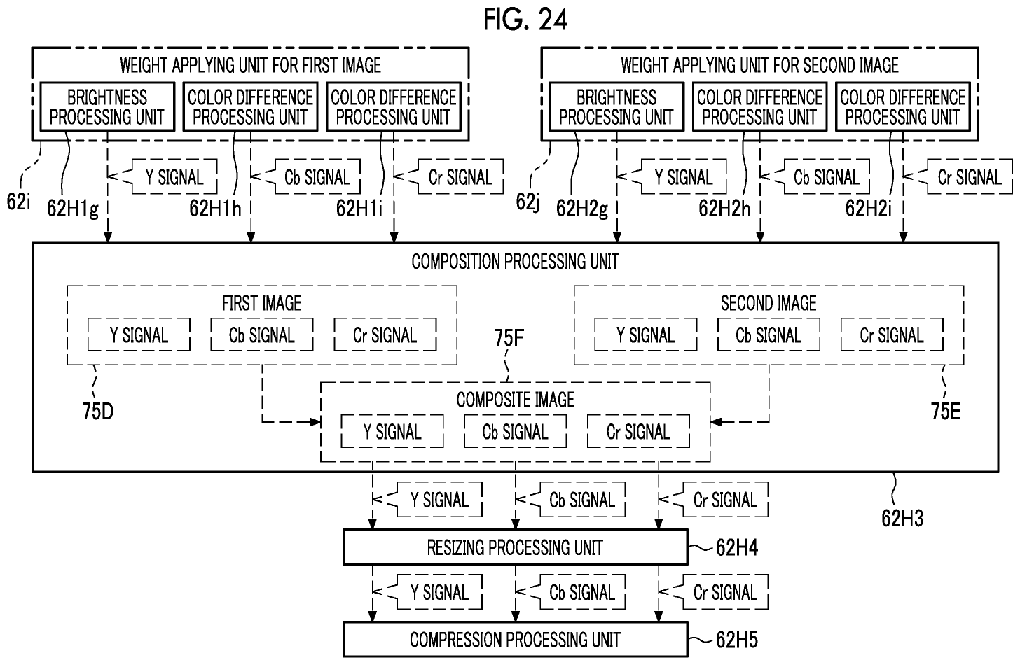

The brightness processing unit 62H1g performs the filtering that uses the brightness filter on the Y signal according to the brightness filter parameters. The weight applying unit 62i for first image acquires the first weight 104 from the weight derivation unit 62C and sets the acquired first weight 104 for the Y signal output from the brightness processing unit 62H1g. As a result, the weight applying unit 62i for first image generates a Y signal having a lower signal level than that of the Y signal (see FIGS. 23 and 24) of the second image 75E.

The color difference processing unit 62H1h performs the filtering that uses a first color difference filter on the Cb signal according to the first color difference filter parameter.

The color difference processing unit 62H1i performs the filtering that uses a second color difference filter on the Cr signal according to the second color difference filter parameter.

The weight applying unit 62i for first image acquires the second weight 106 from the weight derivation unit 62C and sets the acquired second weight 106 to the Cb signal output from the color difference processing unit 62H1h and the Cr signal output from the color difference processing unit 62H1i. As a result, the weight applying unit 62i for first image generates a Cb signal having a higher signal level than that of the Cb signal of the second image 75E (see FIGS. 23 and 24), and a Cr signal having a higher signal level than that of the Cr signal of the second image 75E (see FIGS. 23 and 24)

As an example shown in FIG. 23, the second image processing unit 62H2 includes an offset correction unit 62H2a, which has the same function as the offset correction unit 62F1 described above, a white balance correction unit 62H2b, which has the same function as the white balance correction unit 62F2 described above, a demosaicing processing unit 62H2c, which has the same function as the demosaicing processing unit 62F3 described above, a color correction unit 62H2d, which has the same function as the color correction unit 62F4 described above, a gamma correction unit 62H2e, which has the same function as the gamma correction unit 62F5 described above, a color space conversion unit 62H2f, which has the same function as the color space conversion unit 62F6 described above, and a weight applying unit 62j for second image. The weight applying unit 62j for first image includes a brightness processing unit 62H2g, which has the same function as the brightness processing unit 62F7 described above, a color difference processing unit 62H2h, which has the same function as the color difference processing unit 62F8 described above, and a color difference processing unit 62H2i, which has the same function as the color difference processing unit 62F9 described above.

In a case where the second image 75E is input from the non-AI method processing unit 62B to the second image processing unit 62H2 (see FIG. 21), the offset correction processing, the white balance processing, the demosaicing processing, the color correction processing, the gamma correction processing, and the color space conversion processing are sequentially performed on the second image 75E.

The brightness processing unit 62H2g performs the filtering that uses the brightness filter on the Y signal according to the brightness filter parameters. The weight applying unit 62j for second image acquires the first weight 104 from the weight derivation unit 62C and sets the acquired first weight 104 for the Y signal output from the brightness processing unit 62H2g. As a result, the weight applying unit 62j for second image generates a Y signal having a higher signal level than that of the Y signal (see FIGS. 22 and 24) of the first image 75D.

The color difference processing unit 62H2h performs the filtering that uses a second color difference filter on the Cb signal according to the second color difference filter parameter.

The color difference processing unit 62H2i performs the filtering that uses a second color difference filter on the Cr signal according to the second color difference filter parameter.

The weight applying unit 62j for second image acquires the second weight 106 from the weight derivation unit 62C and sets the acquired second weight 106 to the Cb signal output from the color difference processing unit 62H2h and the Cr signal output from the color difference processing unit 62H2i. As a result, the weight applying unit 62j for second image generates a Cb signal having a lower signal level than that of the Cb signal of the first image 75D (see FIGS. 22 and 24), and a Cr signal having a lower signal level than that of the Cr signal of the second image 75E (see FIGS. 22 and 24).

As an example shown in FIG. 24, the composition processing unit 62H3 acquires the Y signal, the Cb signal, and the Cr signal from the weight applying unit 62i for first image as the first image 75D, and acquires the Y signal, the Cb signal, and the Cr signal from the weight applying unit 62j for second image as the second image 75E. Thereafter, the composition processing unit 62H3 generates the composite image 75F represented by the Y signal, the Cb signal, and the Cr signal by combining the first image 75D represented by the Y signal, the Cb signal, and the Cr signal and the second image 75E represented by the Y signal, the Cb signal, and the Cr signal. The resizing processing unit 62H4 performs the above-mentioned resizing processing on the composite image 75F generated by the composition processing unit 62H3. The compression processing unit 62H5 performs the above-mentioned compression processing on the composite image 75F in which the resizing processing is performed.

As described above, in the present ninth modification example, the signal processing is performed on the first image 75D and the second image 75E such that the signal level of the Y signal of the second image 75E is made higher than that of the first image 75D, and the signal levels of the Cb signal and Cr signal of the first image 75D are made higher than those of the second image 75E. As a result, it is possible to achieve both suppression of the lack of removal of the noise included in the image and suppression of the lack of sharpness of the image as compared with the case where the signal processing is performed on the first image 75D and the second image 75E such that the signal level of the Y signal of the second image 75E is made lower than that of the first image 75D, and the signal levels of the Cb signal and Cr signal of the first image 75D are made lower than the second image 75E.

In the present ninth modification example, although an example of the embodiment in which the signal processing is performed on the first image 75D and the second image 75E such that the signal level of the Y signal of the second image 75E is made larger than that of the first image 75D, and the signal levels of the Cb signal and Cr signal of the first image 75D are made larger than those of the second image 75E has been described, the present disclosed technology is not limited to this. For example, among first processing of lowering the signal level of the Y signal of the second image 75E than that of the first image 75D and second processing of lowering the signal levels of the Cb signal and the Cr signal of the first image 75D than those of the second image 75E, only the first processing may be performed.

Further, in the present ninth modification example, although an example of the embodiment in which the Y signal, the Cb signal, and the Cr signal, which are obtained from the weight applying unit 62i for first image, are used as the first image 75D has been described, the present disclosed technology is not limited to this. For example, the image indicated by the Cb signal and the Cr signal, which are obtained by performing the AI method noise adjustment processing on the RAW image 75A2 for inference, may be used as the first image 75D that is set as a composition target in the composition processing. In this case, for example, the weight with respect to the signal output from the brightness processing unit 62H1g may be set to “0”. Therefore, according to the present configuration, the noise due to brightness can be suppressed as compared with the case where the Y signal is used as the first image 75D.

Further, in the present ninth modification example, although an example of the embodiment in which the Y signal, the Cb signal, and the Cr signal, which are obtained from the weight applying unit 62j for second image, are used as the second image 75E has been described, the present disclosed technology is not limited to this. For example, the image indicated by the Y signal, which is obtained by not performing the AI method noise adjustment processing on the RAW image 75A2 for inference, may be used as the second image 75E that is set as a composition target in the composition processing. In this case, the weight with respect to the signal output from the color difference processing unit 62H2h may be set to “0”, and the weight with respect to the signal output from the color difference processing unit 62H2i may also be set to “0”. Therefore, according to the present configuration, it is possible to suppress a decrease in the sharpness of the microstructure of the composite image 75F obtained by combining the first image 75D and the second image 75E, as compared with the composite image 75F obtained by combining the image, which includes the Cb signal and the Cr signal as the second image 75E, and the first image 75D.

Further, in the present ninth modification example, although an example of the embodiment in which the Y signal, Cb signal, and Cr signal, which are obtained from the weight applying unit 62i for first image, are used as the first image 75D, and the Y signal, the Cb signal, and the Cr signal, which are obtained from the weight applying unit 62j for second image, are used as the second image 75E, has been described, the present disclosed technology is not limited to this. For example, an image indicated by the Cb signal and the Cr signal, which are obtained by performing the AI method noise adjustment processing on the RAW image 75A2 for inference, may be used as the first image 75D that is set as a composition target in the composition processing, and an image indicated by the Y signal, which is obtained by not performing the AI method noise adjustment processing on the RAW image 75A2 for inference, may be used as the second image 75E that is set as a composition target in the composition processing. In this case, for example, the weight with respect to the signal output from the brightness processing unit 62H1g may be set to “0”, the weight with respect to the signal output from the color difference processing unit 62H2h may be set to “0”, and the weight with respect to the signal output from the color difference processing unit 62H2i may be set to “0”. Therefore, according to the present configuration, it is possible to achieve both suppression of the lack of removal of the noise included in the image and suppression of the lack of sharpness of the image as compared with the case where the Y signal, the Cb signal, and the Cr signal are used as the first image 75D, and the Y signal, the Cb signal, and the Cr signal are used as the second image 75E.

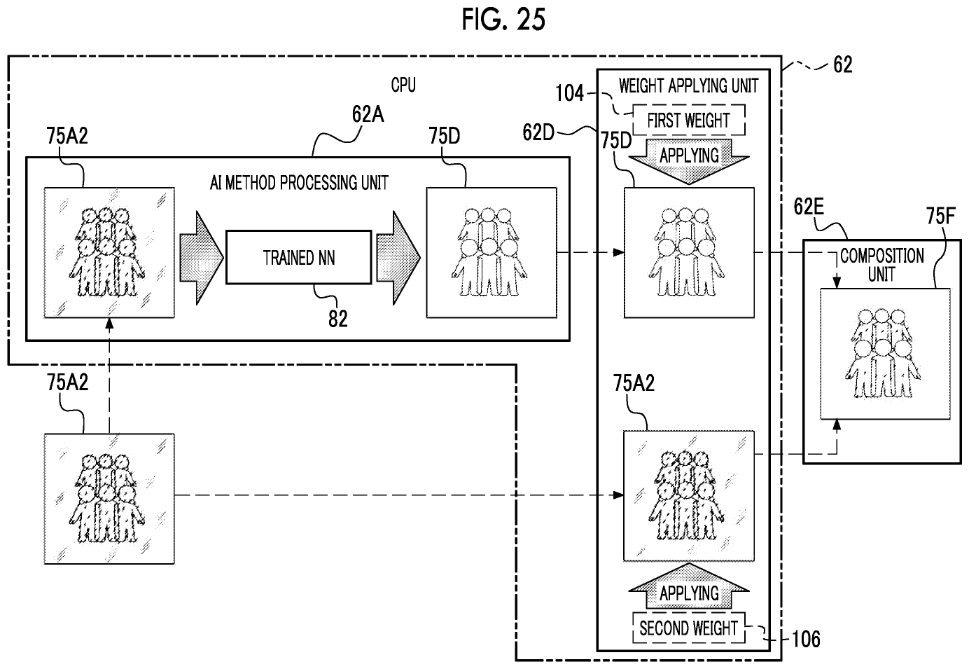

In the above embodiment (for example, the example shown in FIG. 7), although an example of the embodiment in which the second weight 106 is applied to the second image 75E obtained from the RAW image 75A2 for inference by adjusting the noise by using the non-AI method has been described, the present disclosed technology is not limited to this. For example, as an example shown in FIG. 25, the image that is obtained without performing the noise adjustment on the RAW image 75A2 for inference, that is, the second weight 106 may be applied to the RAW image 75A2 for inference. In this case, the RAW image 75A2 for inference is an example of a “second image” according to the present disclosed technology.

As described above, in a case where the second weight 106 is applied to the RAW image 75A2 for inference, the composition unit 62E combines the first image 75D and the RAW image 75A2 for inference according to the first weight 104 and the second weight 106. The brightness is excessively removed from the first image 75D by being discriminated as the noise due to the property of the trained NN 82, but the noise caused by the brightness remains in the RAW image 75A2 for inference to which the second weight 106 is applied. Therefore, by combining the first image 75D and the RAW image 75A2 for inference, it is possible to avoid the disappearance of the microstructure due to the lack of brightness.

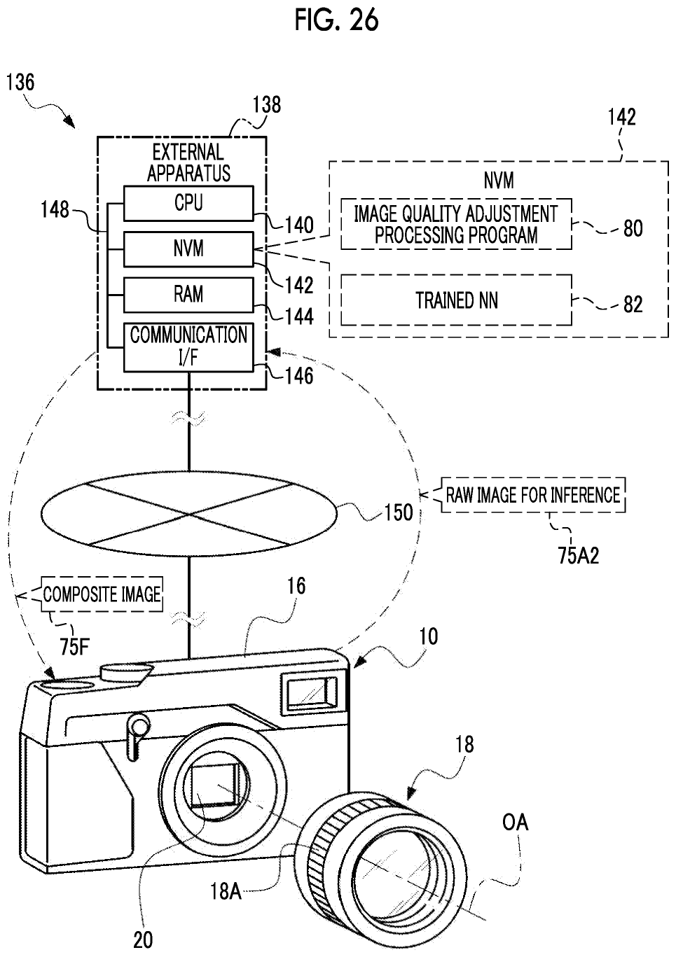

In each of the above examples, although an example of the embodiment in which the image quality adjustment processing is performed by the CPU 62 of the image processing engine 12 included in the imaging apparatus 10 has been described, the present disclosed technology is not limited to this, and the device that performs the image quality adjustment processing may be provided outside the imaging apparatus 10. In this case, as shown in FIG. 26, the imaging system 136 may be used as an example. The imaging system 136 includes the imaging apparatus 10 and an external apparatus 138. The external apparatus 138 is, for example, a server. The server is implemented by cloud computing, for example. Here, although the cloud computing is exemplified, this is only an example, and for example, the server may be implemented by a mainframe or implemented by network computing such as fog computing, edge computing, or grid computing. Here, although a server is exemplified as an example of the external apparatus 138, this is only an example, and at least one personal computer or the like may be used as the external apparatus 138 instead of the server.

The external apparatus 138 includes a CPU 140, an NVM 142, a RAM 144, and a communication I/F 146, and the CPU 140, the NVM 142, the RAM 144, and the communication I/F 146 are connected by a bus 148. The communication I/F 146 is connected to the imaging apparatus 10 via the network 150. The network 150 is, for example, the Internet. The network 150 is not limited to the Internet and may be a WAN and/or a LAN such as an intranet or the like.

The image quality adjustment processing program 80 and the trained NN 82 are stored in the NVM 142. The CPU 140 executes the image quality adjustment processing program 80 in the RAM 144. The CPU 140 performs the above-mentioned image quality adjustment processing according to the image quality adjustment processing program 80 executed on the RAM 144. In a case where the image quality adjustment processing is performed, the CPU 140 processes the RAW image 75A2 for inference by using the trained NN 82 as described in each of the above examples. The RAW image 75A2 for inference is transmitted from the imaging apparatus 10 to the external apparatus 138 via the network 150, for example. The communication I/F 146 of the external apparatus 138 receives the RAW image 75A2 for inference. The CPU 140 performs image quality adjustment processing on the RAW image 75A2 for inference that is received by the communication I/F 146. The CPU 140 generates the composite image 75F by performing image quality adjustment processing and transmits the generated composite image 75F to the imaging apparatus 10. The imaging apparatus 10 receives the composite image 75 transmitted from the external apparatus 138 with the communication I/F 52 (see FIG. 2).

In the example shown in FIG. 26, the external apparatus 138 is an example of the “information processing apparatus” according to the present disclosed technology, the CPU 140 is an example of the “processor” according to the present disclosed technology, and the NVM 142 is an example of the “memory” according to the present disclosed technology.

Further, the image quality adjustment processing may be performed in a distributed manner by a plurality of apparatuses including the imaging apparatus 10 and the external apparatus 138.

Further, in the above embodiment, although the CPU 62 is exemplified, at least one other CPU, at least one GPU, and/or at least one TPU may be used instead of the CPU 62 or together with the CPU 62.

In the above embodiment, although an example of the embodiment in which the image quality adjustment processing program 80 is stored in the NVM 62 has been described, the present disclosed technology is not limited to this. For example, the image quality adjustment processing program 80 may be stored in a portable non-temporary storage medium such as an SSD or a USB memory. The image quality adjustment processing program 80 stored in the non-temporary storage medium is installed in the image processing engine 12 of the imaging apparatus 10. The CPU 62 executes the image quality adjustment processing according to the image quality adjustment processing program 80.

Further, the image quality adjustment processing program 80 may be stored in the storage device such as another computer or a server device connected to the imaging apparatus 10 via the network, the image quality adjustment processing program 80 may be downloaded in response to the request of the imaging apparatus 10, and the image quality adjustment processing program 80 may be installed in the image processing engine 12.

It is not necessary to store all of the image quality adjustment processing programs 80 in the storage device such as another computer or a server device connected to the imaging apparatus 10, or the NVM 62, and a part of the image quality adjustment processing program 80 may be stored.

Further, although the imaging apparatus 10 shown in FIG. 1 and FIG. 2 has a built-in image processing engine 12, the present disclosed technology is not limited to this, for example, the image processing engine 12 may be provided outside the imaging apparatus 10.

In the above embodiment, although the image processing engine 12 is exemplified, the present disclosed technology is not limited to this, and a device including an ASIC, FPGA, and/or PLD may be applied instead of the image processing engine 12. Further, instead of the image processing engine 12, a combination of a hardware configuration and a software configuration may be used.

As a hardware resource for executing the image quality adjustment processing described in the above embodiment, the following various processors can be used. Examples of the processor include software, that is, a CPU, which is a general-purpose processor that functions as a hardware resource for executing the image quality adjustment processing by executing a program. Further, examples of the processor include a dedicated electric circuit, which is a processor having a circuit configuration specially designed for executing specific processing such as FPGA, PLD, or ASIC. A memory is built-in or connected to any processor, and each processor executes the image quality adjustment processing by using the memory.

The hardware resource for executing the image quality adjustment processing may be configured with one of these various processors or may be configured with a combination (for example, a combination of a plurality of FPGAs or a combination of a CPU and an FPGA) of two or more processors of the same type or different types. Further, the hardware resource for executing the image quality adjustment processing may be one processor.

As an example of configuring with one processor, first, one processor is configured with a combination of one or more CPUs and software, and there is an embodiment in which this processor functions as a hardware resource for executing the image quality adjustment processing. Secondly, as typified by SoC, there is an embodiment in which a processor that implements the functions of the entire system including a plurality of hardware resources for executing the image quality adjustment processing with one IC chip is used. As described above, the image quality adjustment processing is implemented by using one or more of the above-mentioned various processors as a hardware resource.

Further, as the hardware-like structure of these various processors, more specifically, an electric circuit in which circuit elements such as semiconductor elements are combined can be used. Further, the above-mentioned image quality adjustment processing is only an example. Therefore, it goes without saying that unnecessary steps may be deleted, new steps may be added, or the processing order may be changed within a range that does not deviate from the purpose.

The contents described above and the contents shown in the illustration are detailed explanations of the parts related to the present disclosed technology and are only an example of the present disclosed technology. For example, the description related to the configuration, function, action, and effect described above is an example related to the configuration, function, action, and effect of a portion according to the present disclosed technology. Therefore, it goes without saying that unnecessary parts may be deleted, new elements may be added, or replacements may be made to the contents described above and the contents shown in the illustration, within the range that does not deviate from the purpose of the present disclosed technology. Further, in order to avoid complications and facilitate understanding of the parts of the present disclosed technology, in the contents described above and the contents shown in the illustration, the descriptions related to the common technical knowledge or the like that do not require special explanation in order to enable the implementation of the present disclosed technology are omitted.

In the present specification, “A and/or B” is synonymous with “at least one of A or B”. That is, “A and/or B” means that it may be only A, it may be only B, or it may be a combination of A and B. Further, in the present specification, in a case where three or more matters are connected and expressed by “and/or”, the same concept as “A and/or B” is applied.

All documents, patent applications, and technical standards described in the present specification are incorporated in the present specification by reference to the same extent in a case where it is specifically and individually described that the individual documents, the patent applications, and the technical standards are incorporated by reference.

Further, the following Appendix will be disclosed with respect to the above embodiments.

(Appendix 1)

An information processing apparatus comprising: a processor; and a memory connected to or built into the processor, wherein the processor is configured to process a captured image by using an AI method that uses a neural network, perform composition processing of combining a first image obtained by processing the captured image by using the AI method, and a second image obtained by processing the captured image without using the AI method, and perform, among first processing of increasing weight of a brightness signal of the second image greater than weight of a brightness signal of the first image and second processing of increasing weight of a color difference signal of the first image greater than weight of a color difference signal of the second image, at least the first processing.

What is claimed is:

1. An information processing apparatus comprising:
a processor; and
a memory connected to or built into the processor,
wherein the processor is configured to
process a captured image by using an AI method that uses a neural network, and
perform composition processing of combining a first image obtained by processing the captured image by using the AI method, and a second image obtained by processing the captured image without using the AI method.

2. The information processing apparatus according to claim 1,
wherein the processor is configured to
perform AI method noise adjustment processing of adjusting noise included in the captured image, by using the AI method, and
adjust the noise by performing the composition processing.

3. The information processing apparatus according to claim 2,
wherein the processor is configured to perform non-AI method noise adjustment processing of adjusting the noise by using a non-AI method that does not use the neural network, and
the second image is an image obtained by adjusting the noise for the captured image by the non-AI method noise adjustment processing.

4. The information processing apparatus according to claim 2,
wherein the second image is an image obtained without adjusting the noise for the captured image.

5. The information processing apparatus according to claim 2,
wherein the processor is configured to
apply weights to the first image and the second image, and
combine the first image and the second image according to the weights.

6. The information processing apparatus according to claim 5,
wherein the weights are classified into a first weight applied to the first image and a second weight applied to the second image, and
the processor is configured to combine the first image and the second image by performing a weighted average that uses the first weight and the second weight.

7. The information processing apparatus according to claim 5,
wherein the processor is configured to change the weight according to related information that is related to the captured image.

8. The information processing apparatus according to claim 7,
wherein the related information includes sensitivity related information that is related to sensitivity of an image sensor used in imaging for obtaining the captured image.

9. The information processing apparatus according to claim 7,
wherein the related information includes brightness related information that is related to brightness of the captured image.

10. The information processing apparatus according to claim 9,
wherein the brightness related information is a pixel statistical value of at least a part of the captured image.

11. The information processing apparatus according to claim 7,
wherein the related information includes spatial frequency information that indicates a spatial frequency of the captured image.

12. The information processing apparatus according to claim 5,
wherein the processor is configured to
detect a subject reflected in the captured image, based on the captured image, and
change the weight according to the detected subject.

13. The information processing apparatus according to claim 5,
wherein the processor is configured to
detect a portion of a subject reflected in the captured image, based on the captured image, and
change the weight according to the detected portion.

14. The information processing apparatus according to claim 5,
wherein the neural network is provided for each imaging scene, and
the processor is configured to
switch the neural network for each imaging scene, and
change the weight according to the neural network.

15. The information processing apparatus according to claim 5,
wherein the processor is configured to change the weight according to a degree of difference between a feature value of the first image and a feature value of the second image.

16. The information processing apparatus according to claim 2,
wherein the processor is configured to normalize an image, which is input to the neural network, with respect to an image characteristic parameter determined according to an image sensor and an imaging condition, which are used for imaging for obtaining an image input to the neural network.

17. The information processing apparatus according to claim 2,
wherein an image for learning, which is input to the neural network in a case where the neural network is trained, is an image in which, with respect to at least one first parameter among the number of bits and an offset value of a first RAW image obtained by being captured by a first imaging apparatus, the first RAW image is normalized.

18. The information processing apparatus according to claim 17,
wherein the captured image is an image for inference,
the first parameter is associated with the neural network to which the image for learning is input, and
the processor is configured to, in a case where a second RAW image, which is obtained by being captured by a second imaging apparatus, is input to the neural network where learning is performed by inputting the image for learning, as the image for inference, normalize the second RAW image by using the first parameter associated with the neural network to which the image for learning is input, and at least one second parameter among the number of bits and an offset value of the second RAW image.

19. The information processing apparatus according to claim 18,
wherein the first image is a noise adjusted image after normalization, which is obtained by adjusting the noise, for the second RAW image that is normalized by using the first parameter and the second parameter, by the AI method noise adjustment processing that uses the neural network where the learning is performed by inputting the image for learning, and
the processor is configured to adjust the noise adjusted image after normalization to an image of the second parameter, by using the first parameter and the second parameter.

20. The information processing apparatus according to claim 2,
wherein the processor is configured to perform signal processing on the first image and the second image according to a designated set value, and
the set value differs between a case where the signal processing is performed on the first image and a case where the signal processing is performed on the second image.

21. The information processing apparatus according to claim 2,
wherein the processor is configured to perform processing of correcting sharpness which is disappeared due to the AI method noise adjustment processing, on the first image.

22. The information processing apparatus according to claim 2,
wherein the first image, which is set as a composition target in the composition processing, is an image indicated by a color difference signal obtained by performing the AI method noise adjustment processing on the captured image.

23. The information processing apparatus according to claim 2,
wherein the second image, which is set as a composition target in the composition processing, is an image indicated by a brightness signal obtained without performing the AI method noise adjustment processing on the captured image.

24. The information processing apparatus according to claim 2,
wherein the first image, which is set as a composition target in the composition processing, is an image indicated by a color difference signal obtained by performing the AI method noise adjustment processing on the captured image, and
the second image is an image indicated by a brightness signal obtained without performing the AI method noise adjustment processing on the captured image.

25. An imaging apparatus comprising:
a processor;
a memory connected to or built into the processor; and
an image sensor,
wherein the processor is configured to
process a captured image, which is obtained by being captured by the image sensor, by using an AI method that uses a neural network, and
perform composition processing of combining a first image obtained by processing the captured image by using the AI method, and a second image obtained by processing the captured image without using the AI method.

26. An information processing method comprising:
processing a captured image, which is obtained by being captured by an image sensor, by using an AI method that uses a neural network; and
performing composition processing of combining a first image obtained by processing the captured image by using the AI method, and a second image obtained by processing the captured image without using the AI method.

27. A non-transitory computer-readable storage medium storing a program executable by a computer to perform a process comprising:
processing a captured image, which is obtained by being captured by an image sensor, by using an AI method that uses a neural network; and
performing composition processing of combining a first image obtained by processing the captured image by using the AI method, and a second image obtained by processing the captured image without using the AI method.
